(19) United States
(12) Patent Application Publication
(10) Pub. No.: US 2012/0084231 A1
(43) Pub. Date: Apr. 5, 2012

(54) Fiber Project Evaluation Tool and Related Methods, Graphical User Interfaces, and Computer-Readable Media

(76) Inventors: Catherine V. McNaught, Conover, NC (US); Ryan M. Spillane, Charlotte, NC (US); Ginger M. Stevens, Hickory, NC (US)

(21) Appl. No.: 12/894,332

(22) Filed: Sep. 30, 2010

(51) Int. Cl. G06F 17/00

(52) U.S. Cl. 705/400

(57) ABSTRACT

Fiber project evaluation tools and related methods, graphical user interfaces (GUIs), and computer-readable media to provide and display cost estimates for a plurality of fiber solutions options that can be employed to deploy a fiber optic network for a fiber project are disclosed. Inputs are provided to allow a user to provide cost-related inputs to customize the cost estimates determined and displayed for the fiber solutions. In this manner, cost estimates can be provided for a variety of fiber solutions at the same time efficiently and visually in a GUI for efficient comparison purposes and to assist in making a choice on a fiber solution for a given fiber project. The cost estimates for the fiber solutions can also be generated and dynamically updated based on providing cost-related inputs to a user that affect the cost estimates for the fiber solutions in an iterative manner.

### BACKGROUND

1. Field of the Disclosure

The technology of the disclosure relates to an interactive processor-based tool, and related methods, graphical user interfaces, and computer-readable media for providing cost-related information for optical fiber-based solutions based in part on user input.

2. Technical Background

Benefits of optical fiber include extremely wide bandwidth and low noise transmission. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic connection equipment, which is also referred to as fiber optic equipment, is located in data distribution centers or central offices to support interconnections.

To provide improved performance to subscribers, fiber optic networks are increasingly providing optical fiber connectivity directly to the subscribers. Given the disparity of requirements in size, location, and deployment topography for subscriber markets, different optical fiber technologies and related components exist to provide fiber optic networks. Each of these solution options has certain characteristics to address requirements of a fiber optic network. For example, a fiber optic network may employ spliced optical fiber solutions. Alternatively, fiber optic networks may employ preconnectorized optical fiber solutions. Equipment included in spliced fiber optic solutions may be less costly that preconnectorized solutions, but labor costs associated with installing and maintaining spliced solutions may be more costly than preconnectorized solutions. Fiber optic networks may also employ a mixture of both spliced and preconnectorized solutions. Further, fiber optic networks involving preconnectorized solutions may have the option of including components that support branch connections and distributed splitting. Given these variations in possible optical fiber solutions, there is a need to provide for an ability of a customer or project manager, as examples, to efficiently rank possible fiber solutions for a fiber optic network based on criteria specific to desired requirements for the fiber optic network.

### SUMMARY OF THE DETAILED DESCRIPTION

Embodiments disclosed in the detailed description include fiber project evaluation tools and related methods, graphical user interfaces (GUIs), and computer-readable media to provide and display cost estimates for a plurality of fiber solutions options that can be employed to deploy a fiber optic network for a fiber project. Inputs are provided to allow a user to provide cost-related inputs to customize the cost estimates determined and displayed for the fiber solutions. In this manner, cost estimates can be provided for a variety of fiber solutions at the same time efficiently and visually in a GUI for efficient comparison purposes and to assist in making a choice on a fiber solution for a given fiber project. The cost estimates for the fiber solutions can also be generated and dynamically updated based on providing cost-related inputs to a user that affect the cost estimates for the fiber solutions in an iterative manner. The cost estimates may be useful as preliminary indicators to narrow down possible fiber solutions to a subset of fiber solutions for a fiber project before a more detailed and timely cost determination is made for each of the subset of the fiber solutions.

In one embodiment, a GUI on an electronic device with memory and one or more processors to execute one or more programs stored in the memory to provide cost estimates for a fiber project is provided. The GUI comprises a graph area. The graph area is comprised of a first axis corresponding to a plurality of fiber solutions for a fiber project. The graph area is also comprised of a second axis corresponding to cost of a fiber project. A plurality of fiber solution cost graphs each corresponding to one of the plurality of fiber solutions in the first axis and a total cost of the fiber project for the corresponding one of the fiber solutions in the second axis is provided. At least one fiber project cost-related input field corresponding to at least one cost-related factor in the total cost of a fiber project and configured to receive a cost-related input from a user that causes the total cost of the fiber project for each of the plurality of fiber solution cost graphs to be dynamically updated in the graph area based on the cost-related input is also provided. A related computer-readable medium for storing one or more programs, the one or more programs comprising instructions, which when executed by an electronic device cause the electronic device to display the GUI to provide cost information for a fiber project is also disclosed in another embodiment.

In another embodiment, a GUI on an electronic device with memory and one or more processors to execute one or more programs stored in the memory to provide cost information for a fiber project is provided. The GUI comprises an incremental fiber cost by year graph comprised of a first axis corresponding to a time period for a fiber project, and a second axis corresponding to a total cost of the fiber project, and a plurality of fiber solution cost graphs each corresponding to the total cost of the fiber project in the first axis and the time period in the second axis. The GUI also comprises an estimated cash flow by year graph comprised of a first axis corresponding to a time period for the fiber project, and a second axis corresponding to cash flow of the fiber project, and a plurality of fiber solution cash flow graphs each corresponding to the cash flow of the fiber project in the first axis and the time period in the second axis. The GUI also comprises a take rate input area comprised of a plurality of expected take rate input fields each corresponding to a time period and each configured to receive expected take rate inputs from a user that cause the cash flow of the fiber project for each of the plurality of fiber solution cash flow graphs to be dynamically updated based on the expected take rate inputs. A related computer-readable medium for storing one or more programs, the one or more programs comprising instructions, which when executed by an electronic device cause the electronic device to display the graphical user interface (GUI) to provide to provide cost information for a fiber project is also disclosed in another embodiment.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a flowchart illustrating an exemplary overall fiber project evaluation (FPE) process configured to be performed by an FPE tool for a fiber project;

FIG. 2 is a schematic diagram of an exemplary basic project input user interface (UI) generated by an FPE tool and provided to a display to allow a user to provide basic project inputs for a fiber project and used by the FPE tool to provide the FPE;

FIG. 3 is a schematic diagram of an exemplary fiber solutions costs UI generated by the FPE tool and provided to a display to allow a user to provide additional project inputs for a fiber project and provide fiber solutions costs based on the basic project inputs and additional project inputs for the fiber project;

FIG. 4 is a schematic diagram of an exemplary fiber solutions costs comparison UI generated by the FPE tool and provided to a display to display information related to a comparison of a subset of user-selected fiber solutions in the fiber solutions costs UI of FIG. 4 for the FPE;

FIG. 5 is a schematic diagram representation of an exemplary machine in the exemplary form of an exemplary computer system adapted to execute instructions from an exemplary computer-readable medium to perform the functions of the FPE tool;

FIG. 6 is a flowchart illustrating processing user inputs entered by a user into the FPE tool for a fiber project as part of an exemplary FPE process configured to be performed by the FPE tool;

FIG. 7 is a schematic diagram of an exemplary adjust labor rates UI generated by the FPE tool and provided to a display to allow a user to adjust labor rates for a fiber project, which are used by the FPE tool to provide the FPE;

FIG. 8 is a flowchart illustrating the FPE tool processing user inputs, including distribution cable placement, entered by a user into the FPE tool for a fiber project as part of an exemplary FPE process configured to be performed by the FPE tool;

FIG. 9 is a schematic diagram of an exemplary distribution cable placement UI generated by the FPE tool and provided to a display to allow a user to enter options for distribution cable placement for a fiber project, which are used by the FPE tool to provide the FPE;

FIG. 10 is a flowchart illustrating processing user inputs, including density and number of homes and businesses, entered by a user into the FPE tool for a fiber project as part of an exemplary FPE process configured to be performed by the FPE tool;

FIG. 11 is a flowchart illustrating the FPE tool processing user inputs entered by the user into the FPE tool to generate and provide to a display a final output of fiber solutions as part of an exemplary FPE process configured to be performed by the FPE tool;

FIG. 12 is a schematic diagram of an exemplary refine project costs UI generated by the FPE tool and provided to a display to allow a user to enter refinements for project costs for a fiber project, which are used by the FPE tool to provide the FPE;

FIG. 13 is a flowchart illustrating the FPE tool processing user inputs, including tasks associated with upfront engineering and overhead, entered by a user into the FPE tool for a fiber project as part of an exemplary FPE process configured to be performed by the FPE tool;

FIG. 14 is a flowchart illustrating the FPE tool processing user inputs, including average monthly subscription and take rate, entered by a user into the FPE tool for a fiber project as part of an exemplary FPE process configured to be performed by the FPE tool;

FIG. 15 is a flowchart illustrating the FPE tool processing user inputs, including expected take rate as a function of time and whether speed of deployment is critical, entered by a user into the FPE tool for a fiber project as part of an exemplary FPE process configured to be performed by the FPE tool;

FIGS. 16A-16C-2 are reports generated by the FPE tool for the FPE of the fiber project; and

FIG. 17 is a schematic diagram of an exemplary FPE tool and database computing and networking architecture embodiments to allow one or more users, either locally or distributed among different locations, to use the FPE tool to create, store, share, and/or manipulate FPEs and associated data locally, at a central server, using a network database, and/or in a peer-to-peer fashion.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include fiber project evaluation tools and related methods, graphical user interfaces (GUIs), and computer-readable media to provide and display cost estimates for a plurality of fiber solutions options that can be employed to deploy a fiber optic network for a fiber project. Inputs are provided to allow a user to provide cost-related inputs to customize the cost estimates determined and displayed for the fiber solutions. In this manner, cost estimates can be provided for a variety of fiber solutions at the same time efficiently and visually in a GUI for efficient comparison purposes and to assist in making a choice on a fiber solution for a given fiber project. The cost estimates for the fiber solutions can also be generated and dynamically updated based on providing cost-related inputs to a user that affect the cost estimates for the fiber solutions in an iterative manner. The cost estimates may be useful as preliminary indicators to narrow down possible fiber solutions to a subset of fiber solutions for a fiber project before a more detailed and timely cost determination is made for each of the subset of the fiber solutions.

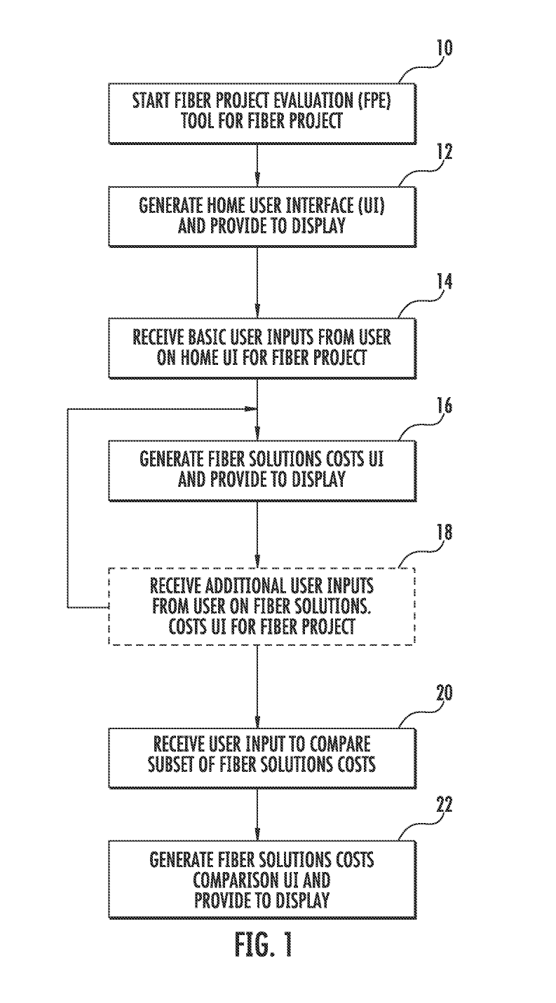

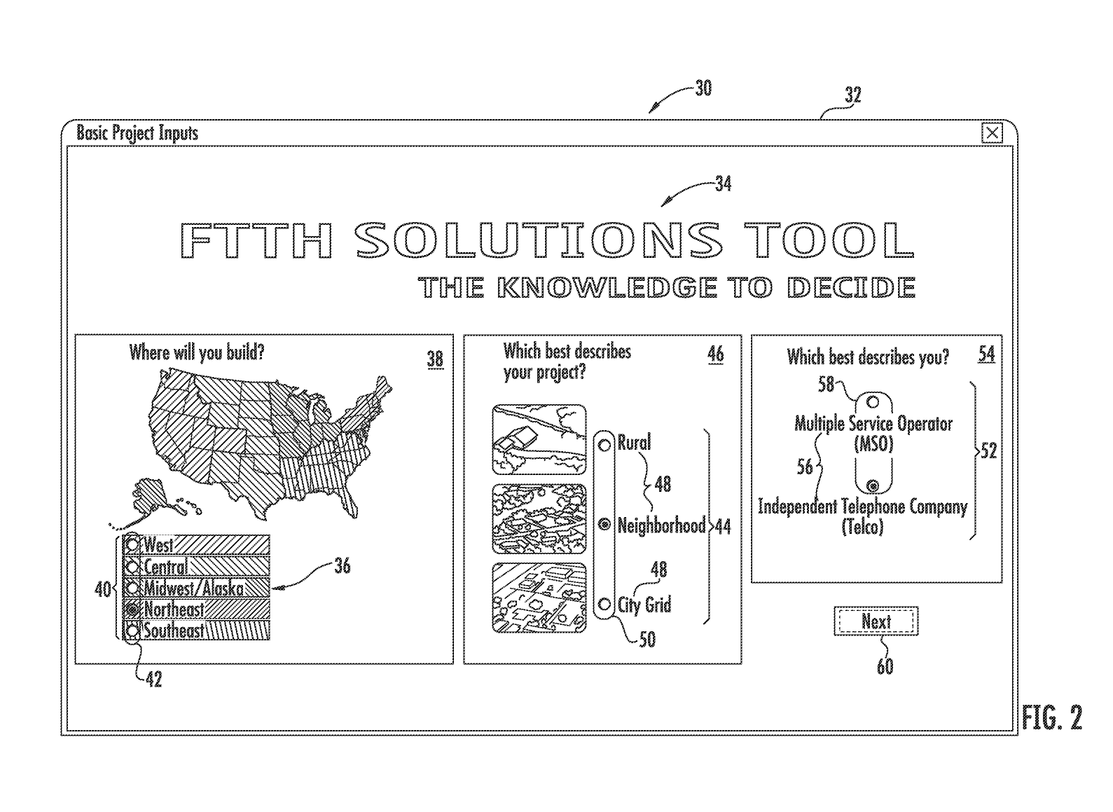

FIG. 1 is a flowchart illustrating an exemplary overall fiber project evaluation (FPE) process configured to be performed by a FPE tool for a fiber project. Examples of the FPE tool that can perform the process in FIG. 1 will be provided in the remainder of this detailed description. With reference to FIG. 1, the FPE tool is started for a fiber project (block 10). The fiber project may be a new fiber project or a previously saved fiber project. The FPE tool will generate a home user interface (UI) and provide the home UI to a display to be reviewed by a user of the FPE tool (block 12). The FPE tool is configured to receive basic user inputs on the home UI regarding the fiber project (block 14). In response, the FPE tool generates a solutions costs comparison UI comprised of a plurality of costs for different fiber solutions for the fiber project, and displays the solutions costs UI to a display to be reviewed by a user (block 16). The FPE tool is configured to allow the user to optionally provide additional user inputs, including revisions to the basic user inputs and other assumptions used by the FPE tool for the fiber project (block 18). The FPE tool will then generate an updated solutions costs comparison UI comprised of a plurality of costs for different fiber solutions for the fiber project (block 16) and for any number of additional user inputs and/or revisions to the basic user inputs (block 18). The FPE tool is configured to receive user input directing the FPE tool to compare a subset of the fiber solutions costs generated for the fiber solutions costs comparison (block 20). In response, the FPE tool will generate a comparison of a subset of fiber solutions costs and provide such to a display for user review (block 22).

The remainder of the detailed description will provide examples of UIs and processes provided by an FPE tool to provide fiber solutions costs evaluations and comparisons of fiber solutions costs for a fiber project as a function of user input regarding characteristics of the fiber project. In this regard, FIG. 2 is a schematic diagram of an exemplary basic project input UI 30 generated by an FPE tool and provided to a display to allowing a user to provide basic project inputs for a fiber project. The basic project input UI 30 is displayed in this embodiment by the FPE tool on a display to a user as the first UI or home UI. The FPE tool will use the basic user inputs for the fiber project to generate fiber solutions costs evaluations and comparisons of fiber solutions costs for the fiber project. As examples and as will be described below in more detail, the FPE tool could be provided by a computer including a processor executing instructions and accessing data associated with the FTE tool provided locally on the computer. Alternatively, the instructions and data associated with the FTE tool could be stored remotely from the computer. The FPE tool could also be provided over a network, such as the Internet, from a server hosting a processor(s) executing instructions. For example, the server could include a web server that provides the basic project input UI 30 and other UIs discussed herein as web pages to an electronic device and/or display using an Internet transfer protocol, including but not limited to HyperText Transfer Protocol (HTTP).

With continuing reference to FIG. 2, the basic project input UI 30 is provided in a basic project input UI window 32 in this embodiment, as illustrated in FIG. 2. This corresponds to blocks 12 and 14 in FIG. 1. The basic project input UI window 32 provides a banner 34 with a title of the FPE tool. The basic project input UI window 32 also provides three (3) basic user prompts to the user to provide basic inputs to define certain basic characteristics for a fiber project that will be used by the FPE tool to provide an FPE for the fiber project. In this regard, the first user prompt is a geographic area prompt 36. The geographic area prompt 36 is provided since the geographic area can affect labor costs for installation and maintenance of the fiber project. Thus, as will be described in more detail below, the FPE tool will use certain pre-programmed default labor rates determined to be an average labor rate for a given geographic area based on selection of the geographic area by the user. The default labor rates are used as part of the cost determination to generate cost estimates of the fiber solutions for the fiber project.

With continuing reference to FIG. 2, the geographic area prompt 36 is provided in a first user prompt area 38 on the basic project input UI window 32. The geographic area prompt 36 provides geographic options 40 for deployment of a fiber project. The user can select one of a number of radio buttons 42 provided for each geographic option 40. With continuing reference to FIG. 2, in this embodiment, the geographic options 40 provided by the FPE tool in the basic project input UI window 32 are for the United States. The geographic options 40 include “West,” “Central,” “Midwest/Alaska,” “Northeast,” and “Southeast.” Thus, different labor rates will be used based on selection by the user of one of these geographic options 40. Note that the FPE tool could be programmed to provide other geographic areas, such as individual states in the United States as well as other countries around the world, as desired.

With continuing reference to FIG. 2, a second user prompt provided on the basic project input UI window 32 is a density prompt 44. The density prompt 44 is provided since the density of the area for deployment of the fiber project can affect the amount of subscribers and equipment to be used for the fiber project. Thus, as will be described in more detail below, the FPE tool will use certain pre-programmed default assumptions on subscribers and equipment as it relates to equipment costs based on selection of the density by the user for deployment of the fiber project for generating estimates of fiber solutions costs for the fiber project.

With continuing reference to FIG. 2, the density prompt 44 is provided in a second user prompt area 46 on the basic project input UI window 32. The density prompt 44 provides density options 48 for deployment of a fiber project. The user can select one of a number of radio buttons 50 provided for each density option 48. In this embodiment, the density options 48 provided by the FPE tool in the basic project input UI window 32 are “Rural,” “Neighborhood,” and “City Grid.” Thus, different subscriber and equipment assumptions will be used based on selection by the user of one of these density options 48. Note that the FPE tool could be programmed to provide other density options, as desired.

With continuing reference to FIG. 2, a third user prompt provided on the basic project input UI window 32 is an operator type prompt 52. The operator type prompt 52 is provided since the type of operator for which the fiber project is deployed can affect the estimated fiber solutions costs for the fiber project. Thus, as will be described in more detail below, the FPE tool will use certain pre-programmed default assumptions on solutions costs as it relates to operator type based on selection of the operator type by the user for deployment of the fiber project for generating estimates of fiber solutions costs for the fiber project.

With continuing reference to FIG. 2, the operator type prompt 52 is provided in a third user prompt area 54 on the basic project input UI window 32. The operator type prompt 52 provides operator type options 56 for deployment of a fiber project. The user can select one of a number of radio buttons 58 provided for each operator type option 56. In this embodiment, the operator type options 56 provided by the FPE tool in the basic project input UI window 32 are “Multiple Service Operator (MSO)” and “Independent Telephone Company (Telco).” Thus, different costs assumptions for fiber solutions will be used based on selection by the user of one of these operator type options 56. Note that the FPE tool could be programmed to provide other operator type options, as desired. Also note that the first user prompt area 38, the second user prompt area 46, and the third user prompt area 54 provided in the basic project input UI window 32 in FIG. 2 could be rearranged to be provided in different areas, rearranged relationally to each other, displayed in a desired ordered sequentially or otherwise, and/or provided to encompass different areas within the basic project input UI window 32 than illustrated in FIG. 2.

After the user has selected the basic project inputs, which in this embodiment are the desired geographic option 40, density option 48, and operator type option 56, the user can select the “Next” button 60 to proceed. As will discussed in more detail below, the user selecting the “Next” button 60 will cause the FPE tool to calculate costs for various programmed fiber solutions for the fiber project based on the basic project inputs and other programmed costs assumptions selected based on the basic project inputs. A cost estimate model may be provided for the fiber project for each fiber solution to calculate the estimated costs for initial installation and/or maintenance of the fiber project for each fiber solution.

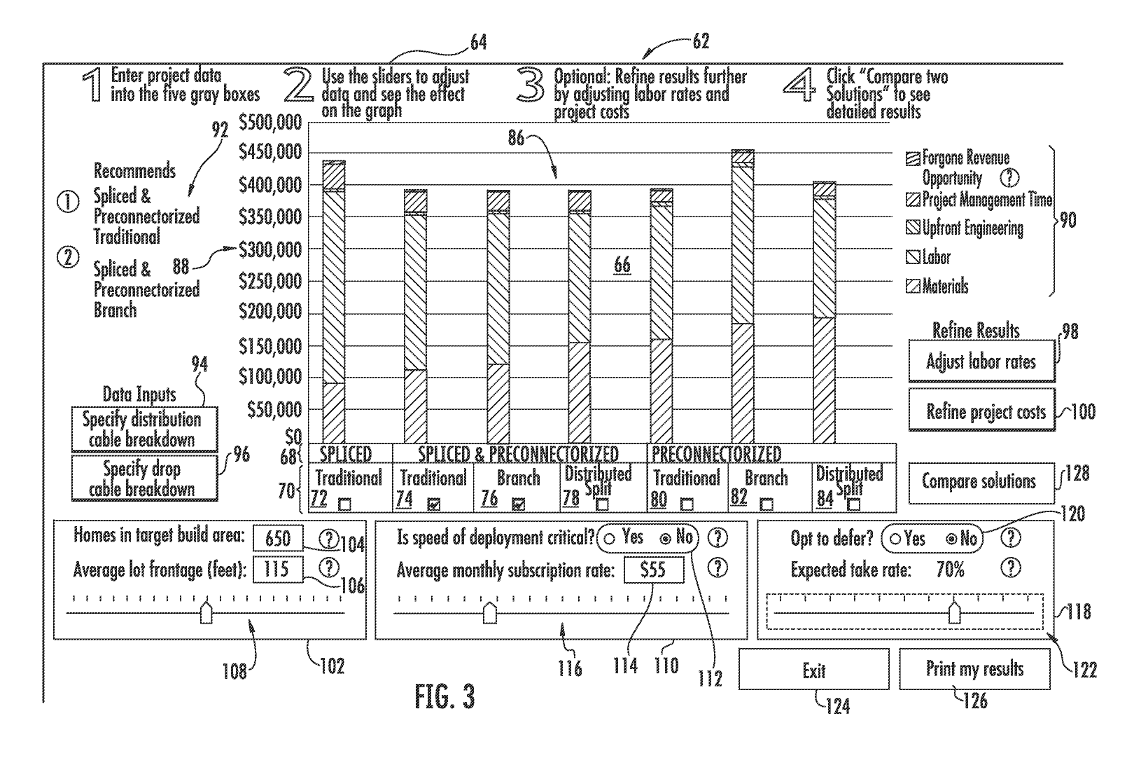

In this embodiment, FIG. 3 is a schematic diagram of an exemplary fiber solutions costs UI 62 generated by the FPE tool and provided to a display in response to the user selecting the “Next” button 60 in the basic project input UI window 32 in FIG. 2. The fiber solutions costs UI 62 provides costs information for different fiber solutions based on the basic project inputs and other information, which may be adjusted by the user in the fiber solutions costs UI 62. In this regard, the fiber solutions costs UI 62 also allows a user to provide additional project inputs for a fiber project and provide solutions costs based on the basic project inputs and additional project inputs for the fiber project. The fiber solutions costs UI 62 is provided in a fiber solutions costs UI window 64 in this embodiment, as illustrated in FIG. 3. This corresponds to blocks 16 and 18 in FIG. 1.

With reference to FIG. 3, the estimated costs for seven (7) different fiber solutions in this embodiment are displayed in a graph area 66 in the fiber solutions costs UI 62. In this manner, the FPE tool presents the user with cost information for all fiber solutions that can easily be deciphered and compared against other fiber solutions to make a determination of the desired fiber solution for accomplishing the fiber project. The seven (7) fiber solutions are provided in fiber solutions categories 68, which are “SPLICED,” “SPLICED & PRECONNECTORIZED,” and “PRECONNECTORIZED.” These are fiber solutions categories that are available to provide for the fiber project. Each has different characteristics, including different associated costs. The “SPLICED” fiber solution corresponds to fiber optic cable and equipment where optical fibers are spliced. The “SPLICED & PRECONNECTORIZED” fiber solution corresponds to fiber optic cable and equipment where optical fibers that include both spliced and preconnectorized optical fibers and compatible equipment. The “PRECONNECTORIZED” fiber solution corresponds to fiber optic cable and equipment where optical fibers include preconnectorized optical fibers and compatible equipment exclusively. Fiber solutions sub-categories 70 exist under the fiber solutions categories 68 to provide seven (7) total unique fiber solutions. As illustrated in FIG. 3, under the “SPLICED” fiber solution, a traditional option 72 is provided. Under the “SPLICED & PRECONNECTORIZED” fiber solution, a traditional option 74, a branch option 76, and a distributed split option 78 are provided. Under the “PRECONNECTORIZED” fiber solution, a traditional option 80, a branch option 82, and a distributed split option 84 are provided.

In general and in a non-limiting manner, the traditional option is associated with a more basic product and component set for a fiber solution, or baseline products. In general and in a non-limiting manner, the branch option is associated with baseline products that also have the capability to branch optical fibers so that the optical fiber is accessed less often in the fiber optic network. In general and in a non-limiting manner, the distributed split option is associated with a branch option that includes multiple splits of the optical fiber.

The calculated cost estimates for each of the fiber solutions sub-categories 70 are displayed by the FPE tool in the graph area 66. In this embodiment, bar graphs 86 are employed. The height of the bar graphs 86 correspond to estimated deployment costs 88 for each fiber solutions sub-category 70. However, the FPE tool provides that each bar graph 86 is separated into individual cost components that add up to provide the total cost. In this manner, the user not only can be provided with the total estimated costs for each fiber solution, but can break up the total costs into useful cost categories or components. In this embodiment, one cost component for the fiber solutions is “Materials” costs. “Materials” costs are the estimated costs of materials required to deploy the fiber project and are shown by the unique hatching in the bottom section of the bar graphs 86 that correspond to a hatching legend 90 on the fiber solutions costs UI window 64. Note that although unique hatchings in the hatching legend 90 are used to show a user the individual cost components that make up a total cost for a particular fiber solution, these hatchings may be shown through other unique means, such as unique colors, shading, or other visual means.

A second cost component for the fiber solutions is “Labor” costs. “Labor” costs are estimated costs for labor to deploy the fiber project shown by the unique hatching in the second from bottom sections of the bar graphs 86 that correspond to the hatching legend 90 on the fiber solutions costs UI window 64. A third cost component for the fiber solutions is “Upfront Engineering” costs. “Upfront Engineering” costs are estimated costs for engineering to deploy the fiber project shown by the unique hatching in the third from bottom sections of the bar graphs 86 that correspond to the hatching legend 90 on the fiber solutions costs UI window 64. A fourth cost component for the fiber solutions is “Project Management Time” costs. “Project Management Time” costs are estimated costs for project management to deploy the fiber project shown by the unique hatching in the fourth from bottom sections of the bar graphs 86 that correspond to the hatching legend 90 on the fiber solutions costs UI window 64. A fifth cost component for the fiber solutions is “Forgone Revenue Opportunity” costs. “Forgone Revenue Opportunity” costs are not actual costs, but are the estimated opportunity costs in forgone revenue due to the duration of network construction. The “Forgone Revenue Opportunity” costs are shown by the unique hatching in the top sections of the bar graphs 86 that correspond to the hatching legend 90 on the fiber solutions costs UI window 64.

The fiber solutions costs UI window 64 also provides additional user inputs that allow a user to provide or adjust certain data used by the FPE tool to calculate and display cost estimates for fiber solutions sub-categories 70. The additional user inputs may allow a user to provide information that is used in place of programmed defaults provided by the FPE tool and/or revise information used by the FPE tool, as examples. When this additional information is provided and/or updated, the FPE tool recalculates the estimated costs for each of the fiber solutions sub-categories 70 and displays the updated cost estimates via the bar graphs 86 in the graph area 66.

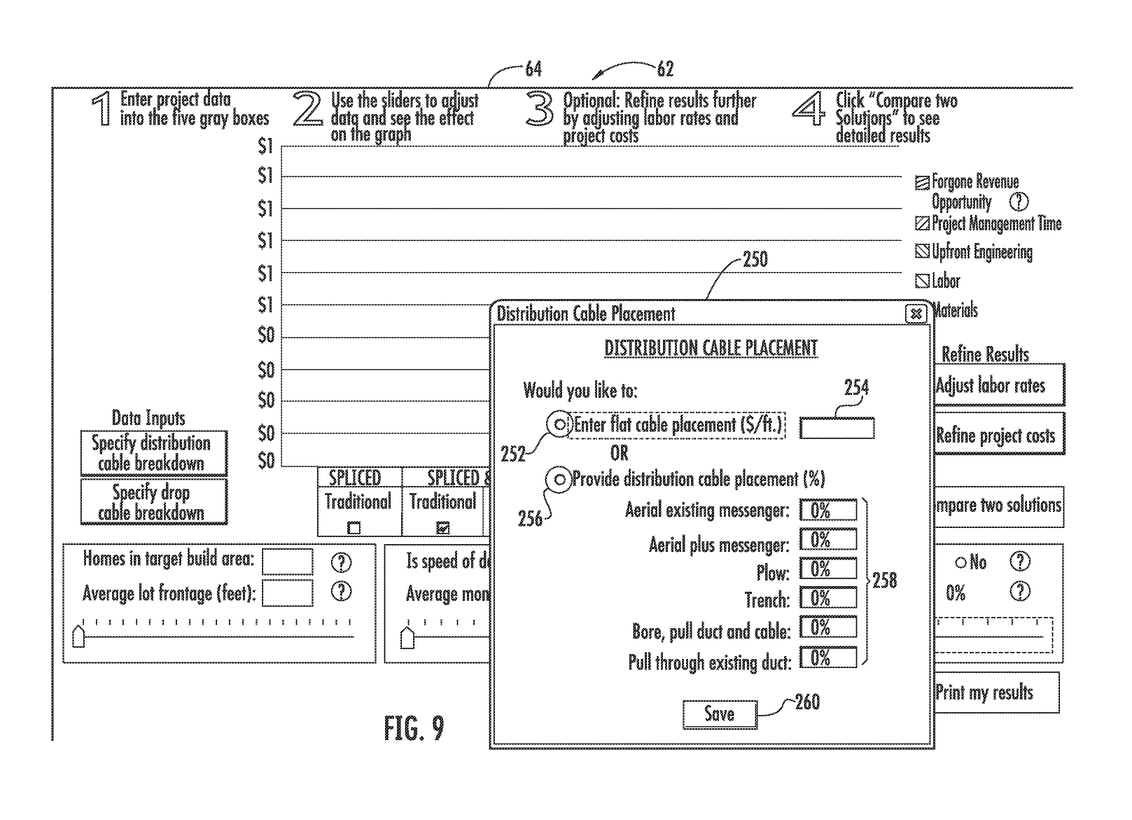

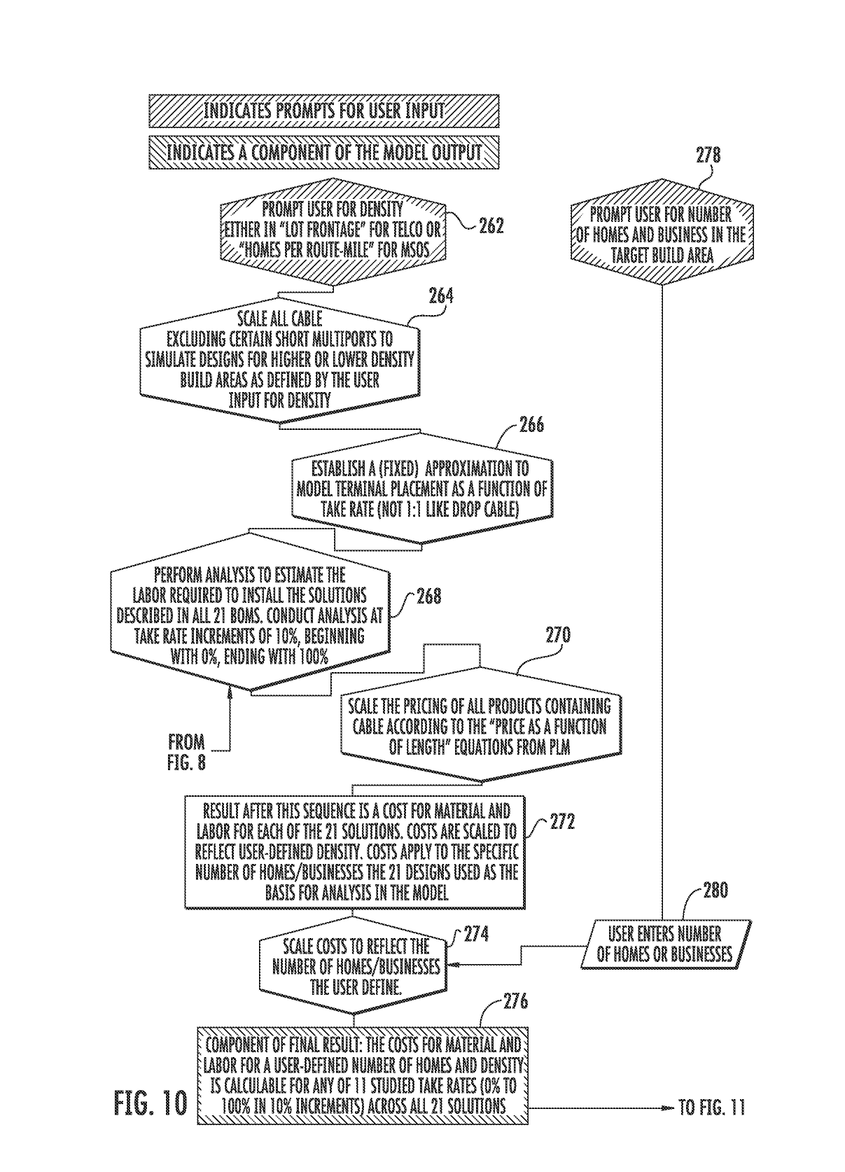

With continuing reference to FIG. 3, one example of an additional user input is fiber optic distribution cable breakdown. The user can select to provide or update information regarding fiber optic distribution cables by selecting a “Specify distribution cable breakdown” button 94 in the fiber solutions costs UI window 64, as illustrated in FIG. 3. Breakdown of fiber optic distribution cable distribution can include, for example, breakdown of flat fiber optic distribution cable and other fiber optic distribution cable characteristics that affect estimated costs of fiber optic distribution cable to deploy the fiber project. More information regarding user-defined specifications of fiber optic distribution cable breakdown is provided in FIGS. 8 and 9 discussed in more detail below. If a user selects the “Specify distribution cable breakdown” button 94 and updates information regarding specifications of fiber optic distribution cable breakdown, the FPE tool will recalculate cost estimates for the fiber solutions sub-categories 70 and display the updated cost estimates as updated bar graphs 86 in the graph area 66 in the fiber solutions costs UI window 64.

With continuing reference to FIG. 3, another example of an additional user input is fiber optic drop cable breakdown. The user can select to provide or update information regarding fiber optic drop cable by selecting the “Specify drop cable breakdown” button 96 in the fiber solutions costs UI window 64, as illustrated in FIG. 3. Breakdown of fiber optic cable distribution can include, for example, aerial, plow, trench, bore, etc. and other fiber optic cable placement methods that contribute to fiber optic cable deployment costs and ultimately, total project cost, and thus affect estimated costs of fiber optic cable to deploy the fiber project. If a user selects the “Specify drop cable breakdown” button 96 and updates information regarding specifications of fiber optic drop cable breakdown, the FPE tool will recalculate cost estimates for the fiber solutions sub-categories 70 and display the updated cost estimates as updated bar graphs 86 in the graph area 66 in the fiber solutions costs UI window 64.

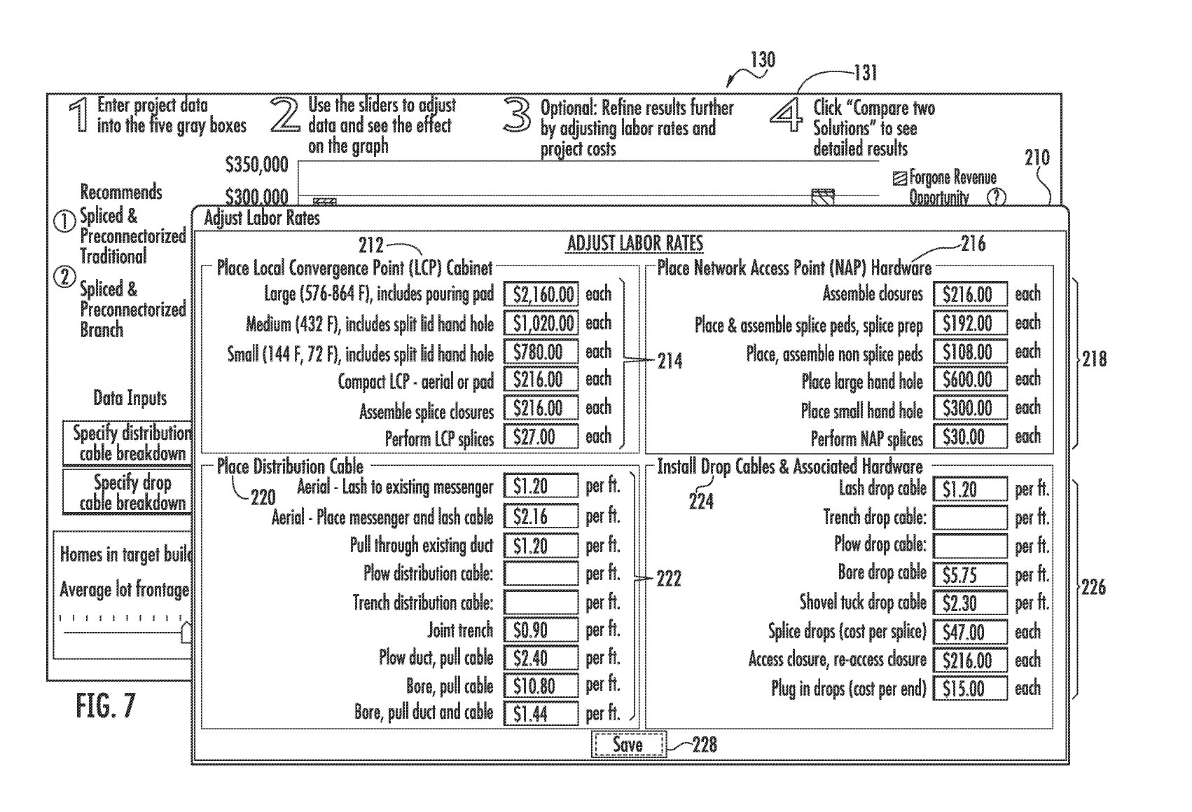

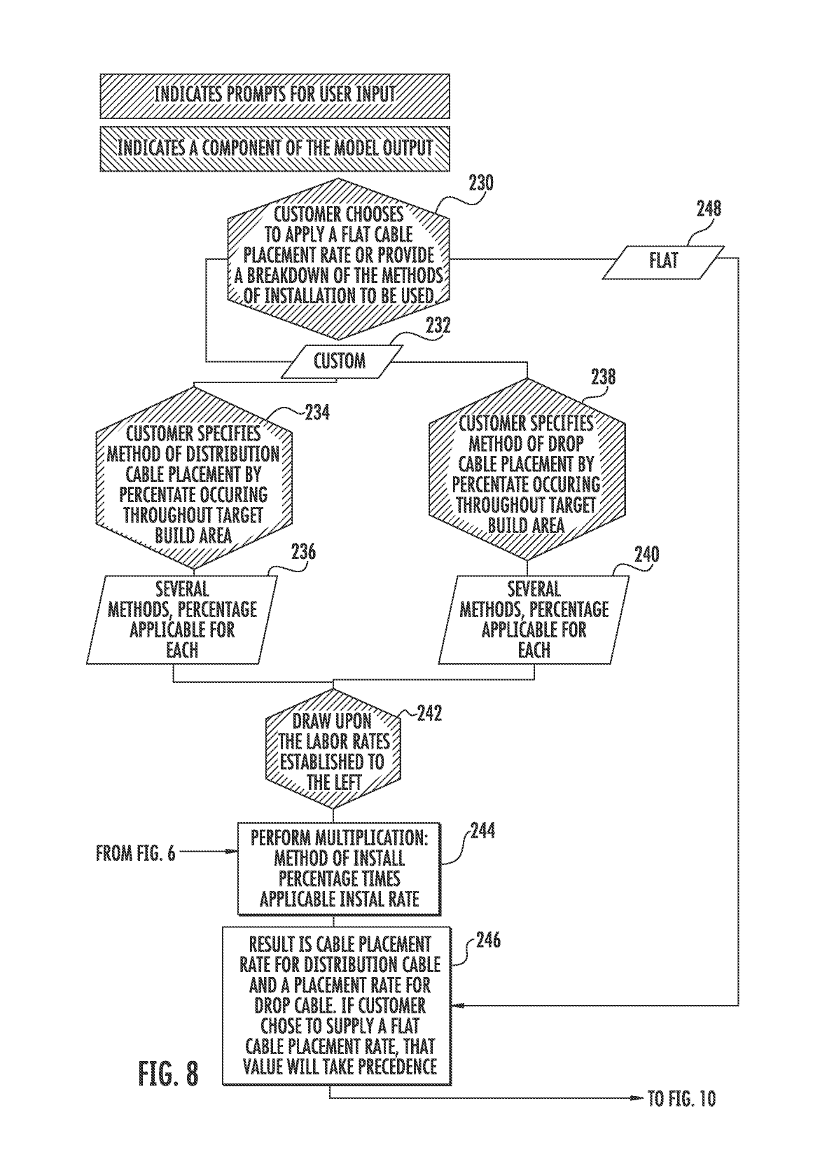

With continuing reference to FIG. 3, another example of an additional user input is to adjust the labor rates used by the FPE tool to calculate the labor cost component of the estimated costs for the fiber solutions sub-categories 70. The user can select to adjust labor rates by selecting the “Adjust labor rates” button 98 in the fiber solutions costs UI window 64, as illustrated in FIG. 3. Adjusting of labor rates can include, for example, different labor rates for categories of labor-related tasks associated with a deployment of a fiber project that affect estimated labor costs, including but not limited to placement of local convergence points (LCPs), placement of network access points (NAPs), placement of fiber optic distribution cable, and installation of fiber optic drop cables and associated equipment. More information regarding adjusting of labor costs by a user is provided in FIGS. 6 and 7 discussed in more detail below. If a user selects the “Adjust labor rates” button 98 and updates information regarding labor rates, the FPE tool will recalculate costs estimates for labor as part of an adjustment of the total cost estimates for the fiber solutions sub-categories 70. The adjusted labor and total cost estimates will be displayed by the FPE tool as updated bar graphs 86 in the graph area 66 in the fiber solutions costs UI window 64.

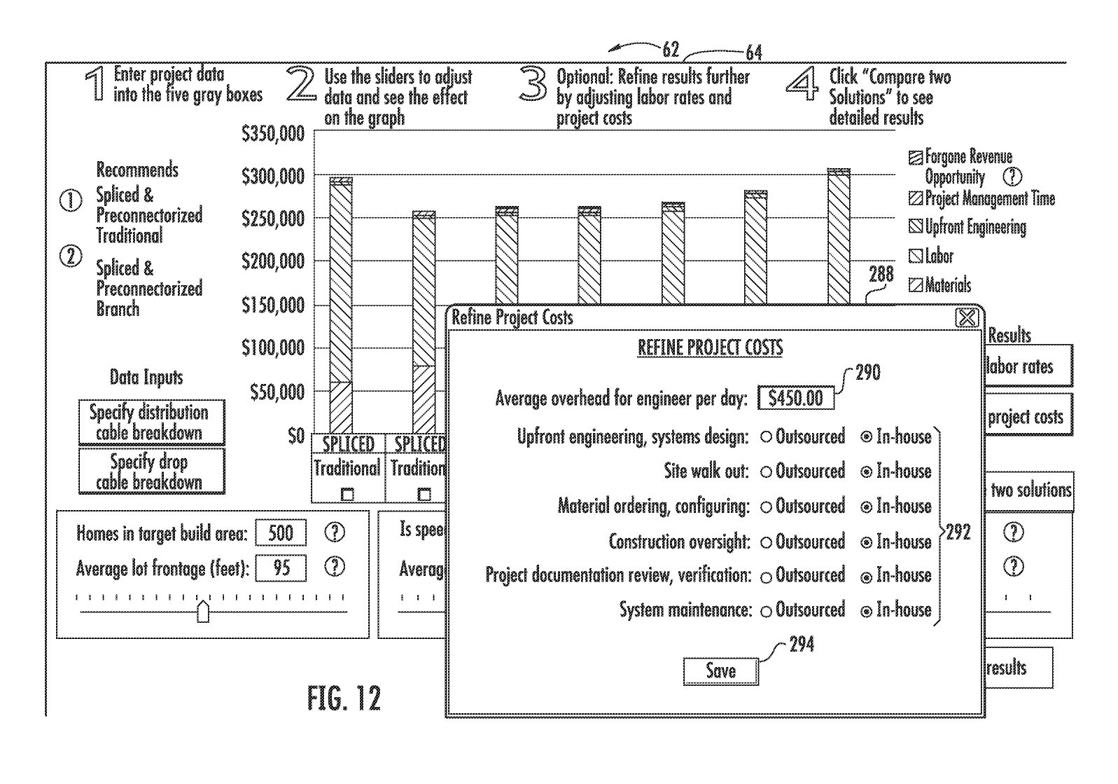

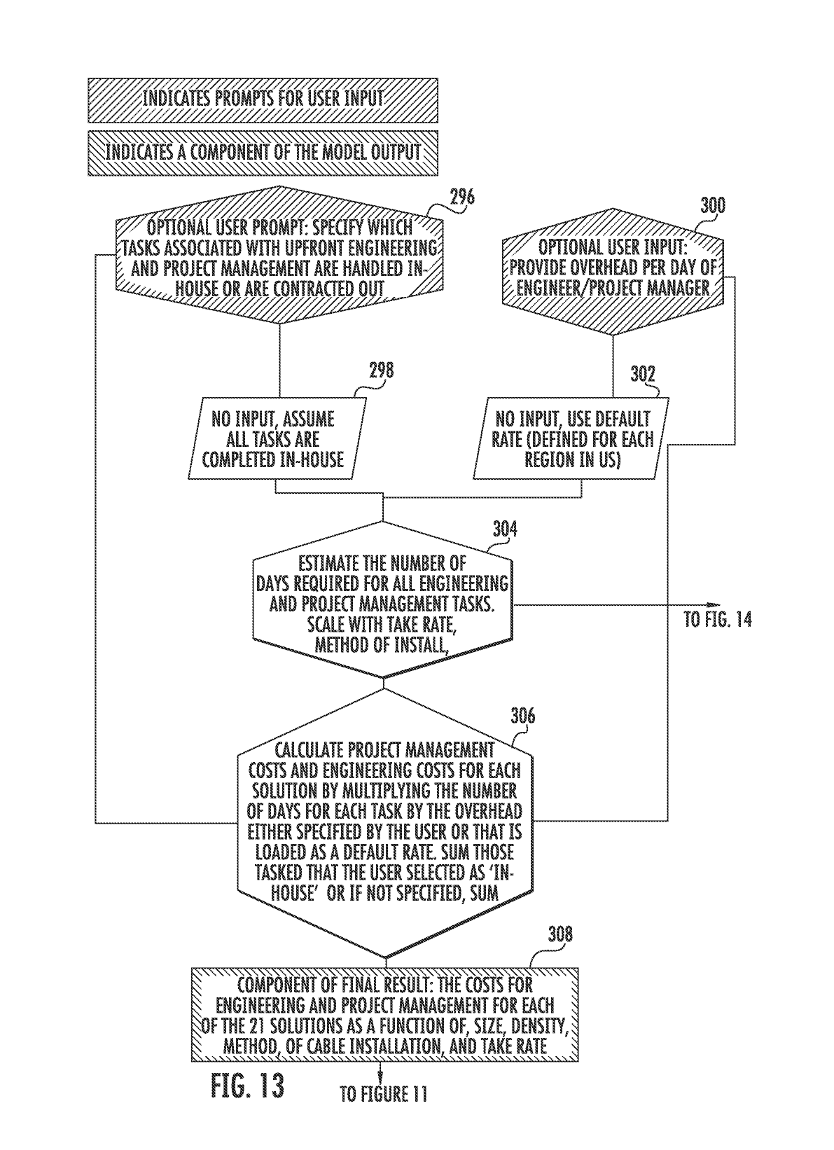

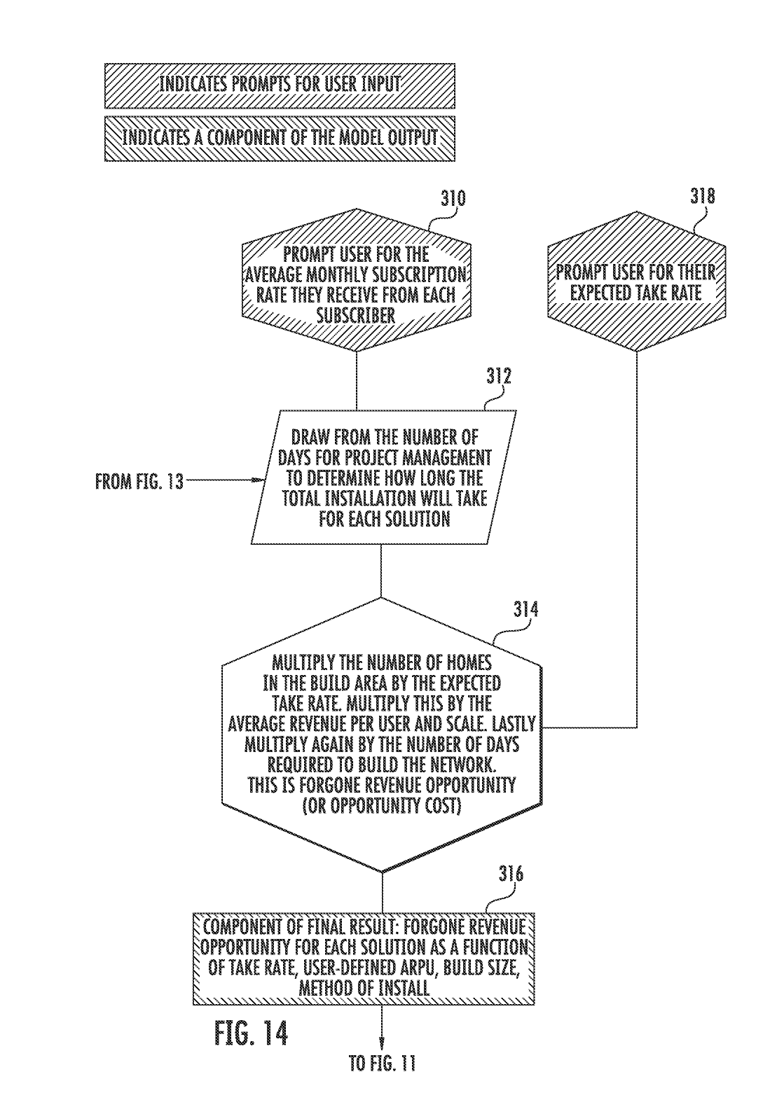

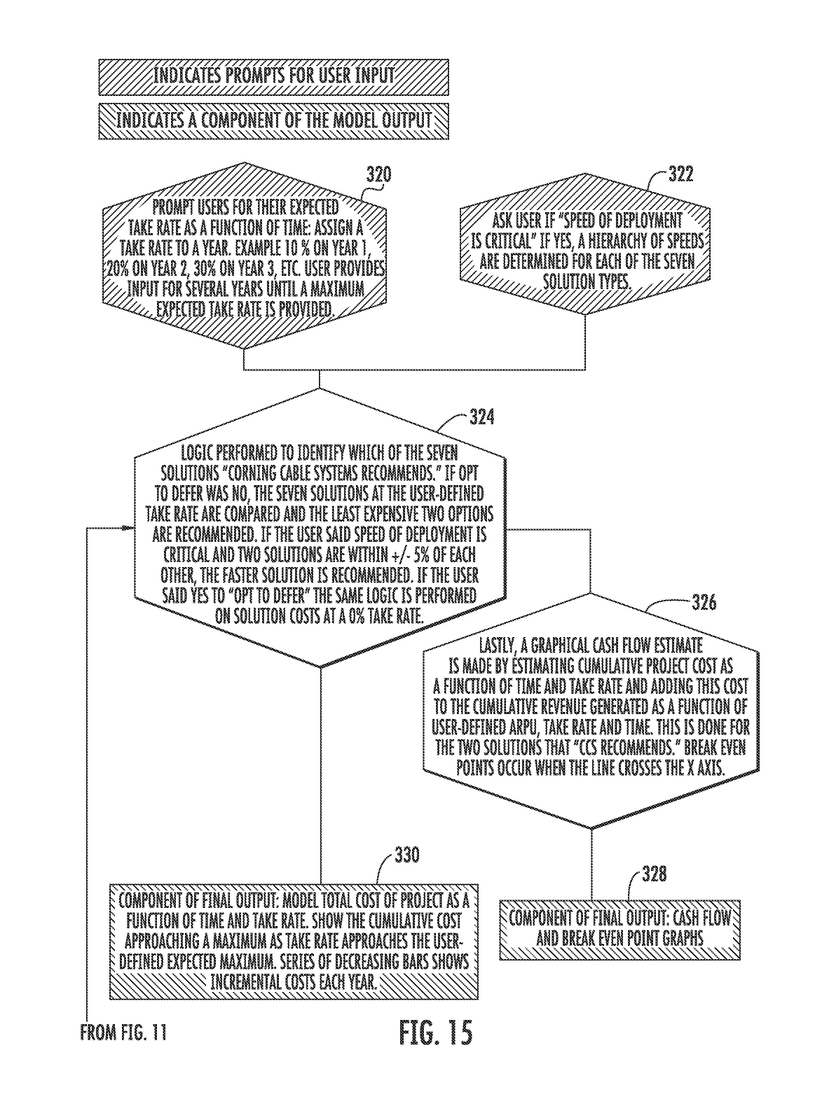

With continuing reference to FIG. 3, another example of an additional user input is to refine project costs used by the FPE tool to calculate the estimated costs for the fiber solutions sub-categories 70. The user can select to refine project costs by selecting the “Refine project costs” button 100 in the fiber solutions costs UI window 64, as illustrated in FIG. 3. Refinement of project costs can include, for example, overhead and whether certain tasks associated with project costs are performed in-house by the fiber project owner or outsourced to a contract firm. More information regarding refinement of project costs by a user is provided in FIGS. 11 and 12 discussed in more detail below. If a user selects the “Refine project costs” button 100 and updates information regarding project costs, the FPE tool will recalculate cost estimates for the fiber solutions sub-categories 70. The adjusted cost estimates will be displayed by the FPE tool as updated bar graphs 86 in the graph area 66 in the fiber solutions costs UI window 64.

With continuing reference to FIG. 3, another example of an additional user input is to refine density specifications used by the FPE tool to calculate the estimated costs for the fiber solutions sub-categories 70. The user selects initial density of the fiber project as part of the basic project inputs discussed above with regard to FIG. 2. However, the fiber solutions costs UI window 64 allows for a user to provide more detailed information regarding density for the FPE tool to use to calculate adjusted cost estimates for the fiber solutions sub-categories 70. In this regard, the fiber solutions costs UI window 64 includes a density user input area 102 whereby the user can provide the number of homes in the target build area for the fiber project in a number of homes field 104. Although the density options 48 selected by the user in FIG. 2 provide certain assumptions of density, these assumptions may not be accurate for a given fiber project. The average lot frontage (in feet) can be input by a user in an average lot frontage field 106. The FPE tool will use these user inputs to adjust the cost estimates of the fiber solutions sub-categories 70 displayed as the bar graphs 86 in the graph area 66 in the fiber solutions costs UI window 64.

The density user input area 102 is strategically located below the graph area 66 so that the user can easily adjust these inputs while seeing the results of the updated cost estimates provided by the FPE tool in the graph area 66. Further, because density is a factor that can greatly affect cost estimates for fiber solutions, a lot frontage slider 108 is provided in the density user input area 102. The user can see the updated cost estimates for the fiber solutions sub-categories 70 provided by the FPE tool in the graph area 66 instantaneously in real-time, or substantially in real-time, as the lot frontage slider 108 is moved left and right by a user to adjust the average lot frontage field 106 set for the fiber project.

With continuing reference to FIG. 3, another example of an additional user input is to provide deployment information, which is used by the FPE tool to calculate the estimated costs for the fiber solutions sub-categories 70. In this regard, the fiber solutions costs UI window 64 includes a deployment input area 110 whereby the user can provide more refined deployment information for the fiber project. Whether speed of deployment of the fiber project is critical or not can be selected by the user according to radio buttons 112. The FPE tool provides initial cost estimates for the fiber solutions sub-categories 70 based on speed of deployment not being critical, but the user can override this decision. Providing for a speed critical deployment of a fiber solution can influence the FPE tool providing recommendations for certain fiber solution sub-categories 70 for the fiber project that allow faster deployment times even if not the least expensive. If the user selects for the speed of the deployment of a fiber solution to be critical, the FPE tool will use this setting to adjust the cost estimates of the fiber solutions sub-categories 70 displayed as the bar graphs 86 in the graph area 66 in the fiber solutions costs UI window 64.

With continuing reference to FIG. 3, another example of an additional user input provided in the deployment input area 110 is the average monthly subscription rate charged to subscribers of services made available by deployment of the fiber project. The average monthly subscription rate can affect the forgone revenue opportunity cost calculated as a result of the deployment time of a fiber project. The longer the deployment time, the greater the forgone revenue opportunity cost component of the estimated cost. Cost estimates for fiber solutions that include longer deployment times will be more greatly influenced by forgone revenue opportunity costs. In this regard, an average monthly subscription rate field 114 is provided to allow a user to enter the average monthly subscription rate used by the FPE tool to calculate cost estimates for the fiber solutions sub-categories 70. The FPE tool may include an initial default average monthly subscription rate in the average monthly subscription rate field 114. If the user changes the average monthly subscription rate in the average monthly subscription rate field 114, the FPE tool will use this setting to adjust the cost estimates of the fiber solutions sub-categories 70 displayed as the bar graphs 86 in the graph area 66 in the fiber solutions costs UI window 64.

The deployment input area 110 is strategically located below the graph area 66 so that the user can easily adjust these inputs while seeing the results of the updated cost estimates provided by the FPE tool in the graph area 66. Further, because the average monthly subscription rate is a factor that can greatly affect cost estimates for fiber solutions in terms of the foregone revenue opportunity component, an average monthly subscription rate slider 116 is provided in the deployment input area 110. The user can see the effect of foregone revenue opportunity in updated cost estimates for the fiber solutions sub-categories 70 provided by the FPE tool in the graph area 66 instantaneously in real-time, or substantially in real-time, as the average monthly subscription rate slider 116 is moved left and right by a user to adjust the average monthly subscription rate.

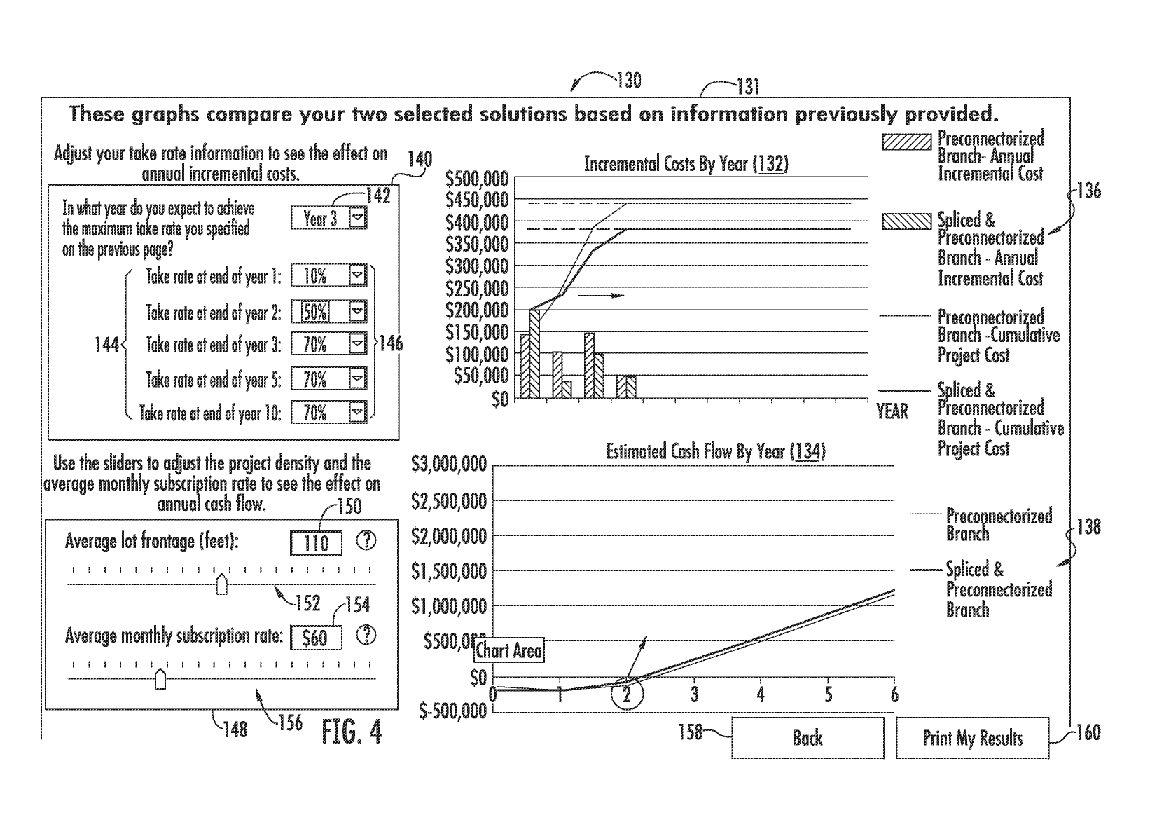

With continuing reference to FIG. 3, another example of an additional user input is to provide additional cost factor information, which is used by the FPE tool to calculate the estimated costs for the fiber solutions sub-categories 70. In this regard, the fiber solutions costs UI window 64 includes a cost factor input area 118 whereby the user can provide more refined cost factor information for the fiber project. Whether the fiber project owner desires to defer as much of the upfront cost for deployment as possible (opt-to-defer) can be selected by the user according to deferment radio buttons 120. For example, many components of a fiber solution do not have to be initially deployed to be able to service subscribers. In this manner, these components that can be deployed later can be deferred thereby reducing upfront costs. However, additional costs may be incurred later when adding components that were initially deferred since the FPE tool provides initial cost estimates for the fiber solutions sub-categories 70 based on costs for deployment not being deferred, but the user can override this decision. If the user opts to defer as much upfront costs as possible, the FPE tool will use this setting to adjust the cost estimate rates for selected fiber solutions sub-categories 70 displayed in the fiber solutions costs comparison UI of FIG. 4, which will be described in more detail below.

With continuing reference to FIG. 3, another example of an additional user input provided in the cost factor input area 118 is the expected take rate of services made available by deployment of the fiber project. Not every possible subscriber will typically sign up for services on initial deployment of a fiber solution. The expected rate can affect the forgone revenue opportunity cost calculated as a result of the deployment time of a fiber project. The longer the deployment time, the greater the forgone revenue opportunity cost component of the estimated cost. Cost estimates for fiber solutions that include longer deployment times will be more greatly influenced by forgone revenue opportunity costs. In this regard, an expected take rate slider 122 is provided to allow a user to change the expected take rate used by the FPE tool to calculate cost estimates for the fiber solutions sub-categories 70. The FPE tool may include an initial default expected take rate. If the user changes the expected take rate using the expected take rate slider 122, the FPE tool will use this setting to adjust the cost estimates of the fiber solutions sub-categories 70 displayed as the bar graphs 86 in the graph area 66 in the fiber solutions costs UI window 64. The FPE tool will also use the expected take rate to adjust the cost estimates rates for selected fiber solutions sub-categories 70 displayed in the fiber solutions costs comparison UI of FIG. 4, which will be described in more detail below.

The cost factor input area 118 is strategically located below the graph area 66 so that the user can easily adjust these inputs while seeing the results of the updated cost estimates provided by the FPE tool in the graph area 66. Further, because the expected take rate is a factor that can greatly affect cost estimates for fiber solutions in terms of the foregone revenue opportunity component, the expected take rate slider 122 is provided in the cost factor input area 118. The user can see the effect of foregone revenue opportunity in updated cost estimates for the fiber solutions sub-categories 70 provided by the FPE tool in the graph area 66 instantaneously in real-time, or substantially in real-time, as the expected take rate slider 122 is moved left and right by a user to adjust the expected take rate.

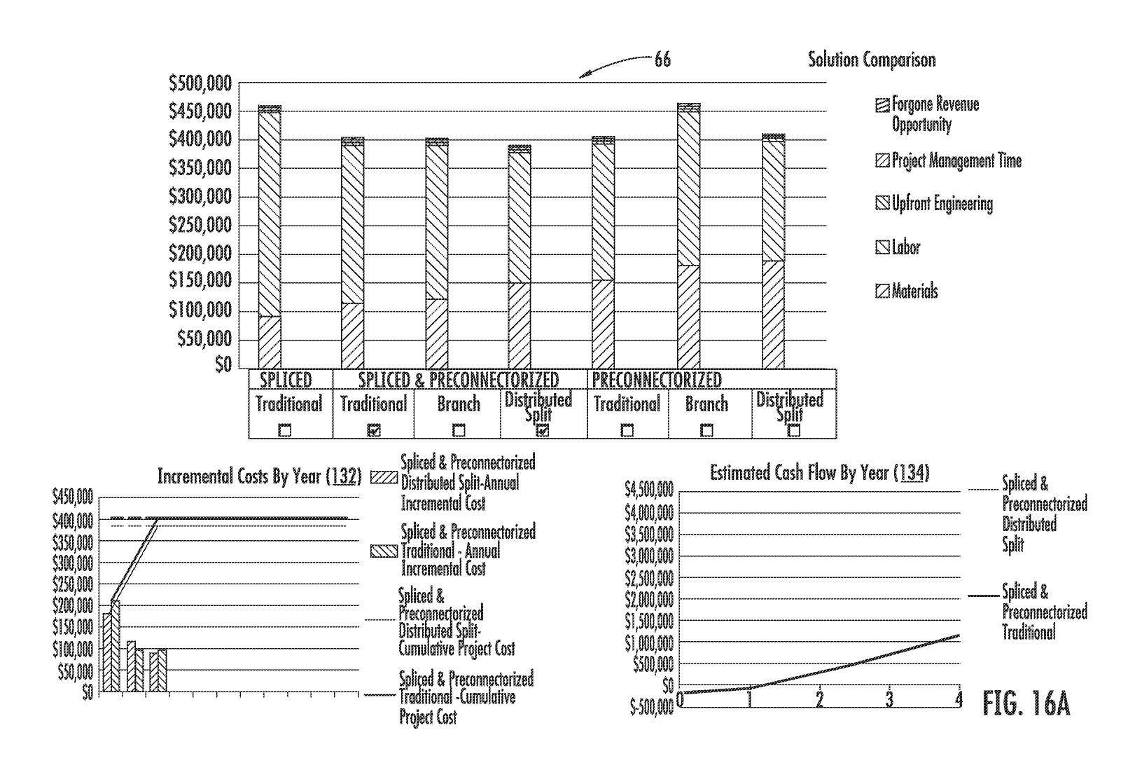

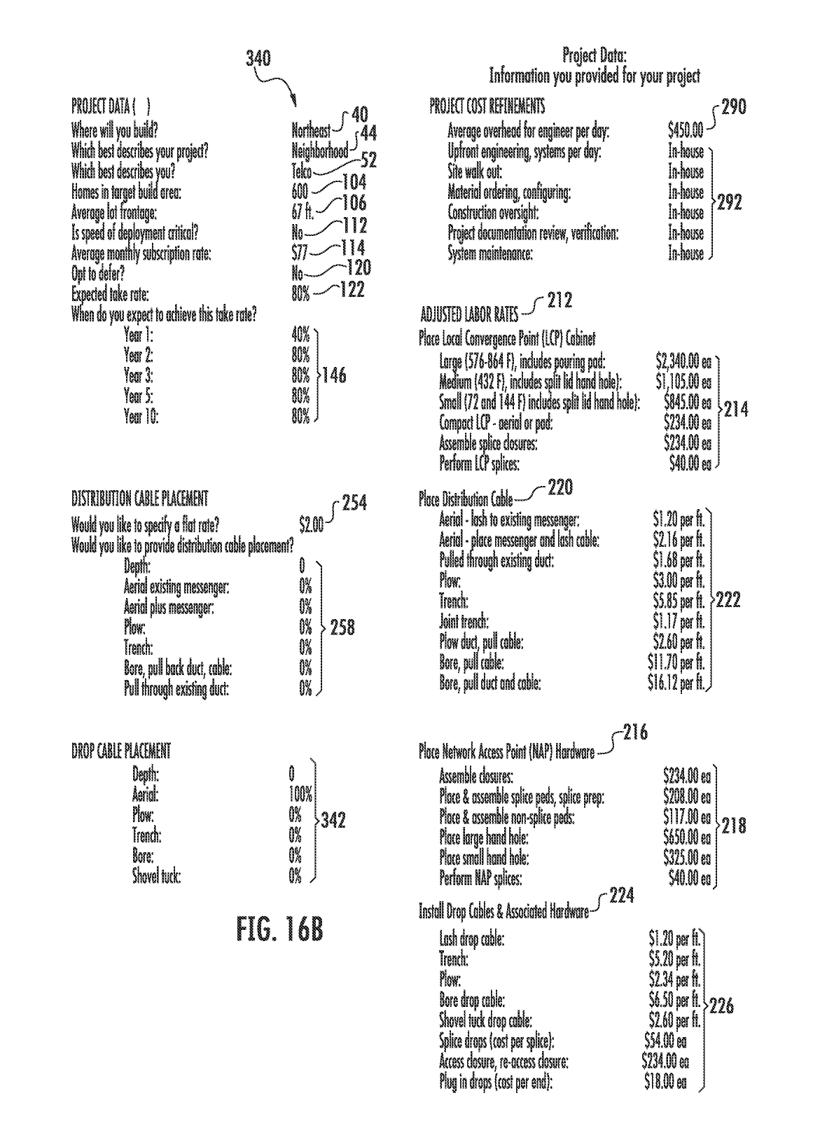

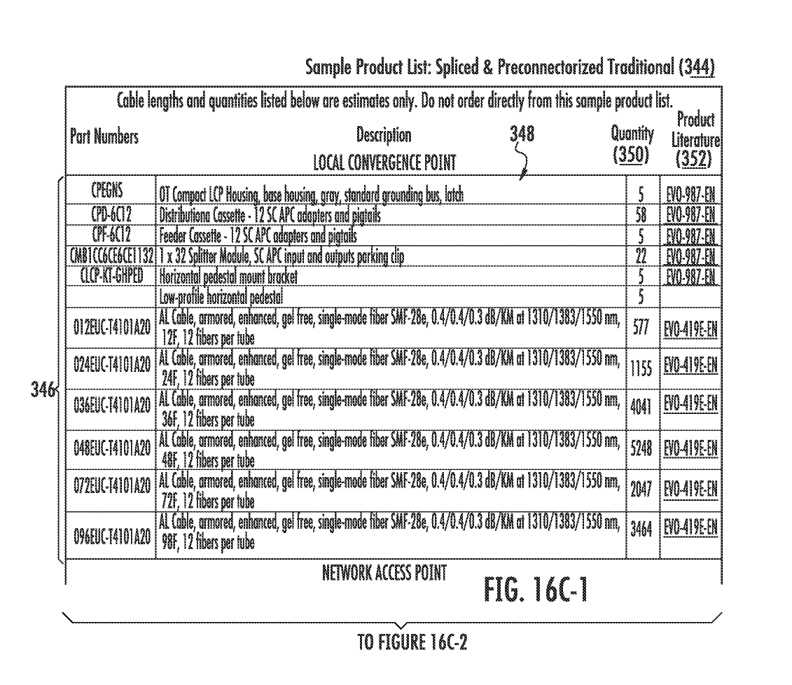

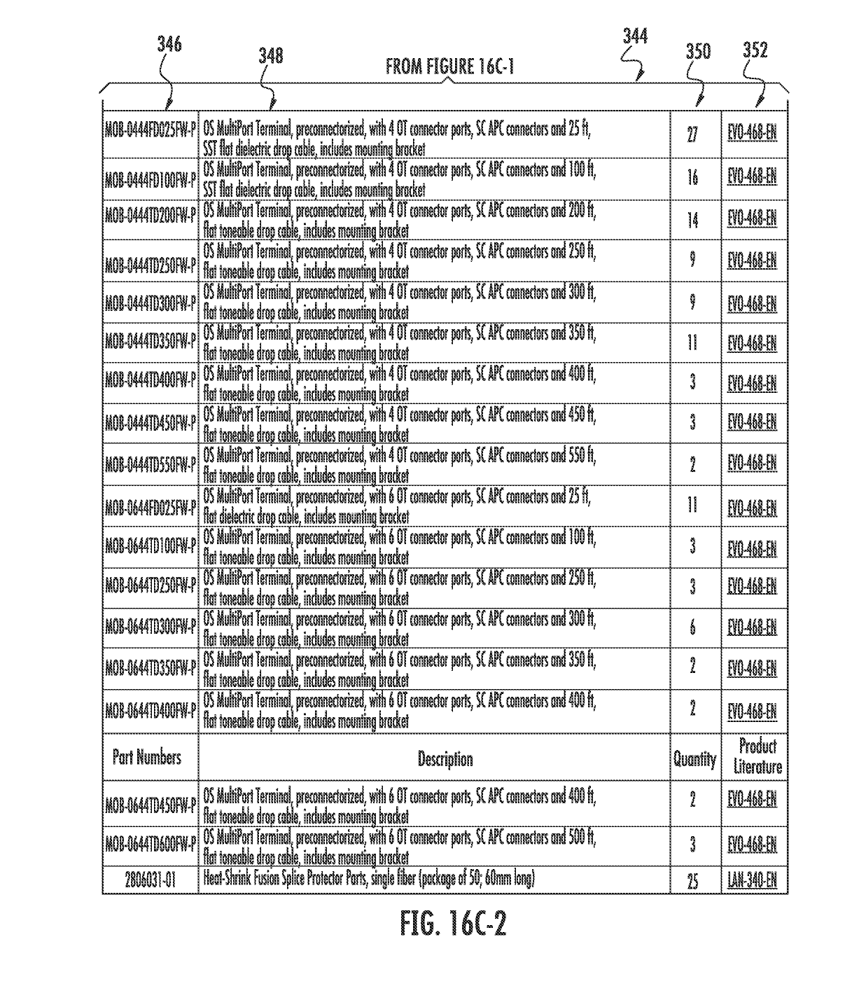

The FPE tool is also configured to provide a recommendation to the user of two (2) fiber solutions sub-categories 70 that should be considered based on the cost information calculated for each of the fiber solutions sub-categories 70. These recommendations are displayed in a recommendation area 92 in the fiber solutions costs UI window 64, as illustrated in FIG. 3. The FPE tool can be configured to provide as fiber solutions recommendations the fiber solutions having the least cost estimate as provided in FIG. 3, or based on other criteria, such as whether speed to deployment is critical, which is discussed in more detail below. The fiber solutions costs UI window 64 also includes an “Exit” button 124 to allow a user to exit the FPE tool. The fiber solutions costs UI window 64 also includes a “Print my results” button 126 to cause the FPE tool to print out a report of results for the fiber project based on the user inputs and the cost estimates calculated by the FPE tool. More information regarding results of the fiber project provided by the FPE tool is provided in FIGS. 16A-16C-2 discussed in more detail below. If a user selects the “Refine project costs” button 100 and updates information regarding project costs, the FPE tool will recalculate cost estimates for the fiber solutions sub-categories 70.

Note that the graph area 66, the hatching legend 90, the “Specify distribution cable breakdown” button 94, the “Specify drop cable breakdown” button 96, the “Adjust labor rates” button 98, the “Refine project costs” button 100, the density user input area 102, the deployment input area 110, the cost factor input area 118, the Exit” button 124, and the “Print my results” button 126 provided in the fiber solutions costs UI window 64 in FIG. 3 could be rearranged to be provided in different areas, rearranged relationally to each other, displayed to the user in a desired ordered sequentially or otherwise, and/or provided to encompass different areas within the fiber solutions costs UI window 64 than illustrated in FIG. 3.

The FPE tool is also configured to provide the ability of a user to compare cost estimates for a subset of fiber solutions sub-categories 70 in more detail in the fiber solutions costs UI window 64. In this regard, the user can select the subset of fiber solutions to compare in more detail by selecting check boxes associated with each of the fiber solutions sub-categories 70, as illustrated in FIG. 3. Once the desired fiber solutions sub-categories 70 to compare in more detail are selected, the user can select a “Compare solutions” button 128. In this embodiment, the FPE tool is configured to compare cost estimates for two (2) fiber solutions sub-categories 70, but the FPE tool could be configured to compare more than two fiber solutions sub-categories 70. In response to a user selection of the “Compare solutions” button 128, the FPE tool generates and provides to a display a solutions costs comparison UI 130 in FIG. 4, discussed in detail below.

The solutions costs comparison UI 130 in FIG. 4 is provided by the FPE tool in a fiber solutions costs comparison UI window 131 that displays for the two (2) selected fiber solutions sub-categories 70 an incremental costs by year graph 132 and an estimated cash flow by year graph 134. Both graphs 132, 134 include bar graphs of costs and cash flow, respectively, for each fiber solutions sub-category 70 selected to compare. If the opt to defer option in the cost factor input area 118 in FIG. 3 is not selected, the incremental costs will be the total cost estimate in the first year. If the opt to defer option in the cost factor input area 118 in FIG. 3 is selected, the incremental costs for the total cost estimate will be shown as spread out over a number of years in the incremental costs by year graph 132. The incremental costs will be incurred as deployment of the fiber project is performed based on cost-related inputs that affect costs for deployment, including average subscription rate and expected take rate, until the cumulative costs are reached. A legend 136 is provided in the fiber solutions costs comparison UI window 131.

The estimated cash flow by year graph 134 is provided to show the estimated cash flow based on cost to deploy the fiber solution and recognizing revenue from subscribers based on the average monthly subscription rate and expected take rates used by the FPE tool. As previously discussed with regard to FIG. 3, the user can provide adjustments to the average monthly subscription rate in the average monthly subscription rate field 114 and the expected take rate using the expected take rate slider 122. As shown in the estimated cash flow by year graph 134, the cash flow is initially negative based on deployment costs of the fiber project, but eventually, the cash flow turns positive as revenues are realized from subscribers. The estimated cash flow by year graph 134 includes estimated cash flow for each fiber solutions sub-category 70 selected by the user in FIG. 3 according to a legend 138 for a user to be able to compare each.

Because expected take rate of services can greatly affect estimated cash flow for a given fiber project, the fiber solutions costs comparison UI window 131 includes an additional take rate input area 140 that allows a user to provide more granularity of expected take rate based on time. For example, the year in which the expected take rate specified in the fiber solutions costs UI window 64 in FIG. 3 by the user by the expected take rate slider 122 can be provided in a maximum take rate drop down box 142. The expected take rates by year can be entered in an expected take rate by year area 144 via drop down boxes 146. As these take rate inputs are adjusted by a user, the FPE tool recalculates the estimated costs and cash flows in the incremental costs by year graph 132 and the estimated cash flow by year graph 134 in the fiber solutions costs comparison UI window 131 in FIG. 4.

Further, because density of area in which the fiber solution is deployed can greatly affect the incremental costs and cash flow for a given fiber project, for the convenience of the user, a density input area 148 is provided in the fiber solutions costs comparison UI window 131 that includes an average lot frontage field 150 and an average lot frontage slider 152, and an average monthly subscription rate field 154 and average monthly subscription rate slider 156. These inputs are provided in the fiber solutions costs UI window 64 in FIG. 3. Alternatively, the user could select the “Back” button 158 in the fiber solutions costs comparison UI window 131 to allow the user to refine any of the inputs provided in the fiber solutions costs UI window 64 in FIG. 3 for the FPE tool to recalculate estimated costs and/or to allow the user to select other subsets of fiber solutions sub-categories 70 to compare in the fiber solutions costs comparison UI window 131 in FIG. 4. The fiber solutions costs comparison UI window 131 also includes a “Print my results” button 160 to cause the FPE tool to print out a report of results for the fiber project based on the user inputs and the cost estimates calculated by the FPE tool. More information regarding results of the fiber project provided by the FPE tool is provided in FIGS. 16A-16C-2 discussed in more detail below.

Note that the incremental costs by year graph 132, the estimated cash flow by year graph 134, the legend 136, the legend 138, the additional take rate input area 140, the average lot frontage field 150, the “Back” button 158, and the “Print my results” button 160 provided in the fiber solutions costs comparison UI window 131 in FIG. 4 could be rearranged to be provided in different areas, rearranged relationally to each other, displayed to the user in a desired ordered sequentially or otherwise, and/or provided to encompass different areas within the fiber solutions costs comparison UI window 131 than illustrated in FIG. 4.

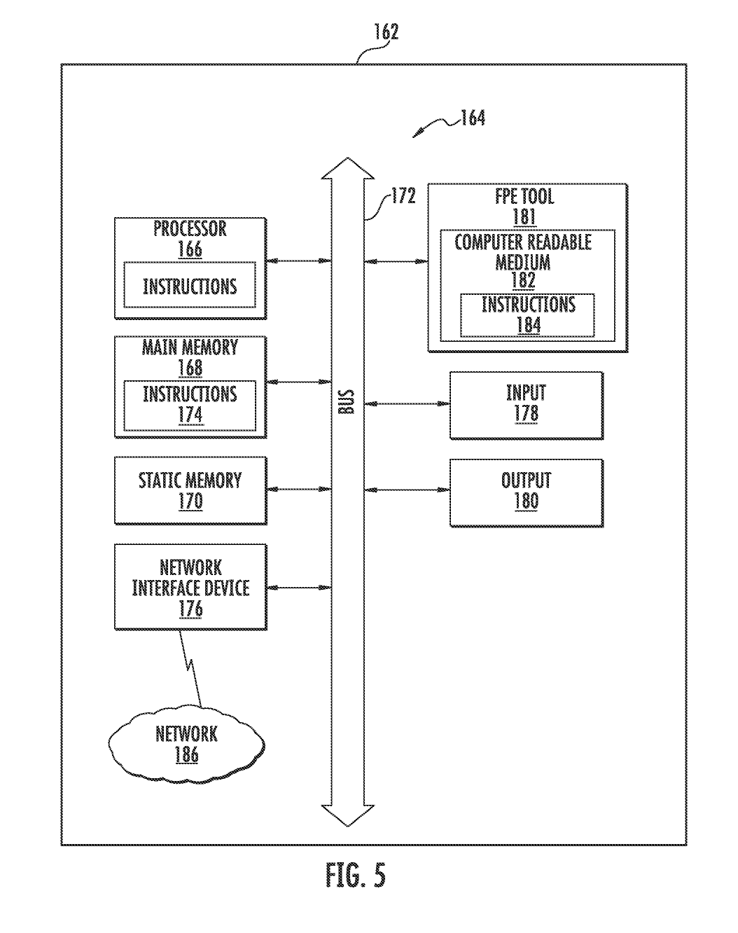

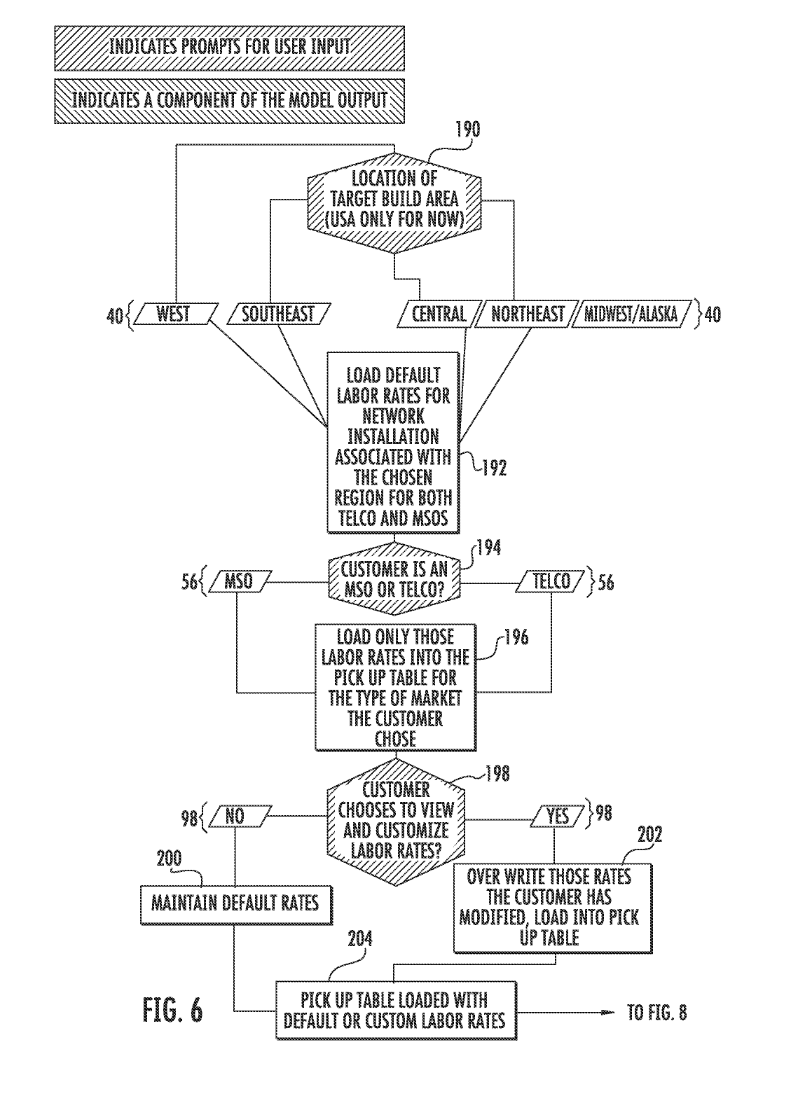

FIG. 5 is a schematic diagram representation of an exemplary machine 162 in the exemplary form of an exemplary computer system 164 adapted to execute instructions from an exemplary computer-readable medium to perform the functions of the FPE tool according to one embodiment. In this regard, the machine 162 may comprise the computer system 164 within which a set of instructions for causing the machine 162 to perform any one or more of the methodologies discussed herein may be executed. The machine 162 may be connected (e.g., networked) to other machines in a local area network (LAN), an intranet, an extranet, or the Internet. The machine 162 may operate in a client-server network environment, or as a peer machine in a peer-to-peer (or distributed) network environment. While only a single machine 162 is illustrated, the term “machine” shall also be taken to include any collection of machines that individually or jointly execute a set (or multiple sets) of instructions to perform any one or more of the methodologies discussed herein. The machine 162 may be a server, a personal computer, a desktop computer, a laptop computer, a personal digital assistant (PDA), a computing pad, a mobile device, or any other device and may represent, for example, a server or a user's computer.

The exemplary computer system 164 includes a processing device or processor 166, a main memory 168 (e.g., read-only memory (ROM), flash memory, dynamic random access memory (DRAM) such as synchronous DRAM (SDRAM), etc.), and a static memory 170 (e.g., flash memory, static random access memory (SRAM), etc.), which may communicate with each other via a bus 172. Alternatively, the processing device 166 may be connected to the main memory 168 and/or static memory 170 directly or via some other connectivity means.

The processing device 166 represents one or more general-purpose processing devices such as a microprocessor, central processing unit, or the like. More particularly, the processing device 166 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 166 is configured to execute processing logic in instructions 174 for performing the operations and steps discussed herein.

The computer system 164 may further include a network interface device 176. It also may or may not include an input 178 to receive input and selections to be communicated to the computer system 164 when executing instructions. It also may or may not include an output 180, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 164 may or may not include a data storage device that includes an FPE tool 181 stored in computer-readable medium 182 on which is stored one or more sets of instructions 184 (e.g., software) embodying any one or more of the methodologies or functions described herein. The instructions 184 may also reside, completely or at least partially, within the main memory 168 and/or within the processing device 166 during execution thereof by the computer system 164, the main memory 168 and the processing device 166 also constituting machine-accessible storage media. The instructions 184 may further be transmitted or received over a network 186 via the network interface device 176.

While the machine-accessible storage medium 182 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the embodiments disclosed herein. The term “machine-accessible storage medium” shall accordingly be taken to include, but not be limited to, solid-state memories, optical and magnetic media, and carrier wave signals.

FIGS. 6-16C-2 discussed below provide more detail on exemplary processes that can be provided in instructions for the FPE tool 181 that can be executed by the processing device 166 to provide the UIs, receive user inputs, calculate cost estimates for fiber solutions, and otherwise display information to a display for a user. In this regard, FIG. 6 is a flowchart illustrating displaying of the basic project inputs UI window 32 in FIG. 2 and processing basic project inputs entered by a user into the FPE tool 181 for a fiber project as part of an exemplary FPE process configured to be performed by the FPE tool 181. For example, the flowchart in FIG. 6 may correspond to blocks 12 and 14 in FIG. 1.

With reference to FIG. 6, the FPE tool 181 waits until the user enters the selection for the geographic option 40 for the fiber project (block 190). As discussed previously, the user will choose either “West,” “Central,” “Midwest/Alaska,” “Northeast,” and “Southeast.” After the user selects the desired geographic option 40, the FPE tool 181 loads the default labor rates for a network installation associated with the chosen geographic region for both TELCOs and MSOs (block 192). As previously discussed and discussed in more detail below, the user can override default labor rates or use the default labor rates provided by the FPE tool for purposes of the FPE tool calculating cost estimates for fiber solutions. After the user selects whether the customer for the fiber project is an MSO or TELCO (block 194), by selecting the operator type options 56 provided by the FPE tool in the basic project input UI window 32 in FIG. 2, the FPE tool 181 loads those labor rates that affect the operator type chosen to be later used for determining cost estimates (block 196).

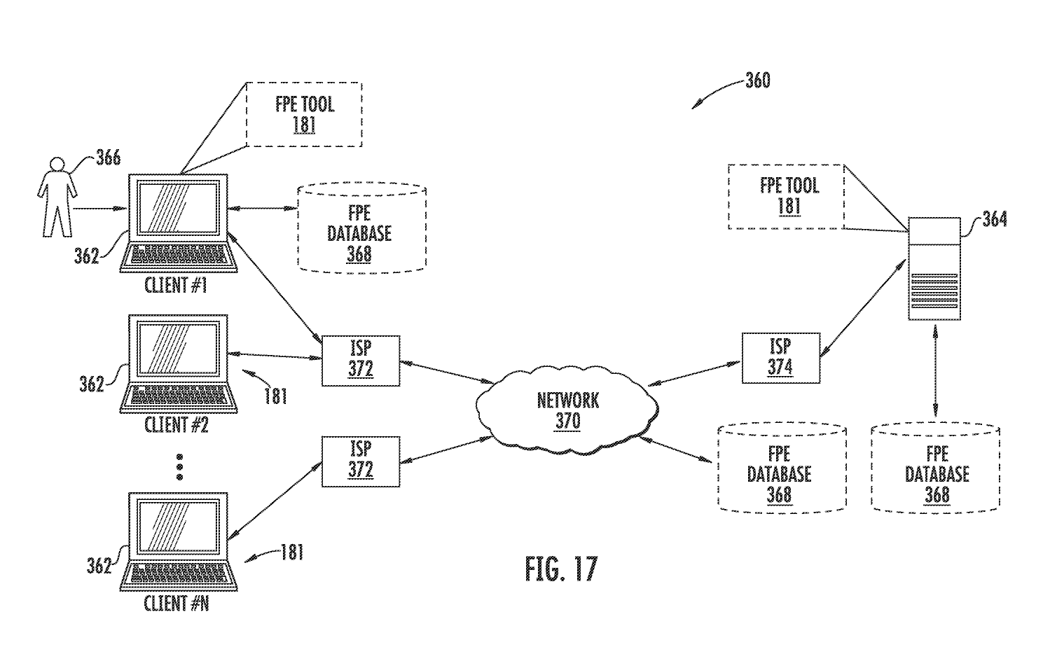

As previously discussed, the user can choose to customize labor rates used by the FPE tool 181 to provide cost estimates by selecting the “Adjust labor rates” button 98 in the fiber solutions costs UI window 64 in FIG. 3 (block 198 in FIG. 6). If the user does not choose to customize labor rates, the FPE tool 181 maintains the default labor rates (block 200) and uses a table in an FPE tool database 368 (FIG. 17) loaded with the default labor rates (block 204) to calculate cost estimates. If the user chooses to customize labor rates, the FPE tool 181 overwrites the default labor rates with the customized labor rates (block 202), which are then used in a table in the FPE tool database 368 loaded with the default labor rates (block 204) to calculate cost estimates.

As an example of a UI generated by the FPE tool 181 to allow a customer to customize labor rates, FIG. 7 is provided. FIG. 7 in a schematic diagram of an exemplary adjust labor rates UI window 210 generated by the FPE tool 181 and provided to a display to allow a user to adjust labor rates for a fiber project in response to the user selecting the “Adjust labor rates” button 98. As illustrated in FIG. 7, the adjust labor rates UI window 210 provides areas for placement of an LCP 212, placement of an NAP hardware 216, placement of fiber optic distribution cable 220 and installation of fiber optic drop cables and associated hardware 224. In each of these areas, input fields 214, 218, 222, and 226 are provided to allow the user to input customized labor rates for various tasks or items associated with placement of an LCP 212, placement of an NAP hardware 216, placement of fiber optic distribution cable 220 and installation of fiber optic drop cables and associated hardware 224, respectively. Note that the FPE tool 181 may load the fields 214, 218, 222, and 226 with the default rates such that the user does not have to enter labor rates for the fields 214, 218, 222, and 226 where the default labor rate is desired or acceptable. Alternatively, the FPE tool 181 could provide for the fields 214, 218, 222, and 226 to be blank where the user can override the default labor rates if the user enters a custom labor rate in such fields 214, 218, 222, and 226. After the user has provided any customized labor rates, where such labor rates are stored by the user selecting the “Save” button 228.

FIG. 8 is a flowchart that includes the FPE tool 181 processing user inputs, including distribution cable placement, entered by a user for a fiber project in response to a user selecting to provide information regarding fiber optic cable specifications. In this regard, as previously discussed, the user can select to provide information relating to fiber optic distribution cable breakdown by selecting the “Specify distribution cable breakdown” button 94 in the fiber solutions costs UI window 64 in FIG. 3. If selected by the user (block 230 in FIG. 8), the FPE tool 181 generates and displays a distribution cable placement UI window 250, as illustrated in FIG. 9. The user can select either flat cable placement (block 248 in FIG. 8) or custom cable placement (block 232 in FIG. 8), by selecting either the flat cable placement radio button 252 or the distribution cable placement radio button 256, respectively, in the distribution cable placement UI window 250 in FIG. 9. If the user selects the flat cable placement radio button 252, the user can enter a dollars per square foot cost in a cost field 254 (block 248 in FIG. 8). If the user selects the distribution cable placement radio button 256, the user can enter percentages of distribution cable placement for the fiber project in placement fields 258 (blocks 234-240 in FIG. 8). After the user has entered any customized distribution cable placement figures, the user can select the “Save” button 260 to save the figures to update such figures for use by the FPE tool 181 in the FPE tool database 368 (block 242 in FIG. 8).

With continuing reference to FIG. 8, the FPE tool 181 performs multiplication of the method of installation percentages default rates or customized rates from the user in the placement fields 258 in FIG. 9, multiplied by the applicable installation rates from the labor rates (block 244). The result is a cable placement rate for fiber optic distribution cable and a placement rate for fiber optic drop cable (block 246). If the user chooses to supply a flat cable placement (block 248), that value will take precedence over the cable placement rate for fiber optic distribution cable and a placement rate for fiber optic drop cable for determining cost of fiber optic cable and associated installation costs.

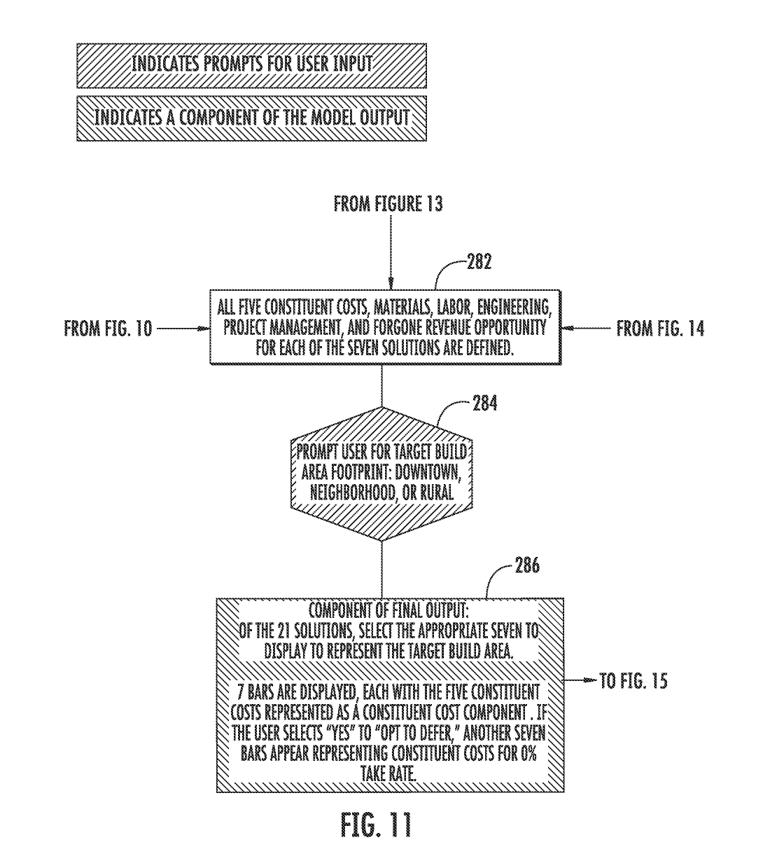

FIG. 10 is a flowchart illustrating the FPE tool 181 processing user inputs, including density inputs, entered by a user for a fiber project. As previously discussed, the density user input area 102 in the fiber solutions costs UI window 64 in FIG. 3 is provided to allow a user to provide more specific density information if desired to be used by the FPE tool 181 to determine cost estimates. In this regard, when the user enters an average lot frontage in the average lot frontage field 106 (block 262 in FIG. 10), the FPE tool 181 will use these user inputs to adjust the cost estimates of the fiber solutions sub-categories 70 displayed as the bar graphs 86 in the graph area 66 in the fiber solutions costs UI window 64 in FIG. 3. The FPE tool 181 will scale all cable excluding certain short multiports to simulate designs for higher or lower density build areas as defined by the user input for density (block 264). The FPE tool 181 will establish an approximation to model terminal placement as a function of the specified or default take rate (block 266). The FPE tool 181 will perform an analysis to estimate the labor required to install the fiber solutions sub-categories 70 and conduct an analysis at certain take rate increments, which can be ten percent (10%) increments beginning with zero percent (0%) and ending with one-hundred percent (100%) (block 268).

With continuing reference to FIG. 10, the FPE tool 181 scales the pricing of all products in the fiber solutions models containing fiber optic cable according to price as a function of length (block 270). The result is a cost for material and labor for each of the fiber solutions sub-categories 70 (block 272). Costs are then scaled by the FPE tool 181 to reflect user-defined density (blocks 272). Costs are then scaled by the FPE tool 181 to the specific number of homes for each of the fiber solutions sub-categories 70 (block 274). The FPE tool 181 then scales the cost estimates to reflect the number of homes for density, which can either be user-defined according to the specific number of homes entered by the user in the target build area for the fiber project in the number of homes field 104 in FIG. 3 (blocks 278, 280), or a default number of homes. The FPE tool 181 provides the final result of the costs for materials and labor as a function of density specifications and take rates at specified increments for each of the fiber solutions sub-categories 70 (block 276).

FIG. 11 is a flowchart illustrating the FPE tool 181 building estimated costs for each of the fiber solutions sub-categories 70 based on default and user inputs to provide the cost estimate bar graphs 86 in the graph area 66 of the fiber solutions costs UI window 64 in FIG. 3. All five (5) cost components previously discussed and illustrated in FIG. 3 are calculated by the FPE tool 181 based on applying the default and user inputs for the fiber project into models for each of the fiber solutions sub-categories 70 (block 282). Based on the user input for the density options 48 in the basic project input UI window 32 in FIG. 2 as either “Rural,” “Neighborhood,” and “City Grid” (block 284), the FPE tool 181 determines the final estimated component and total costs of the fiber solutions sub-categories 70 and displays such in the bar graphs 86 in the graph area 66 of the fiber solutions costs UI window 64 in FIG. 3, as previously discussed (block 286).

Other data used by the FPE tool 181 to determine the estimated costs of the fiber solutions can also be made available by the FPE tool 181 to the user for refinement. For example, the FPE tool 181 can provide a refine project costs UI window 288 in FIG. 12 to allow the user to provide information regarding project costs that can be used by the FPE tool 181 to determine estimated costs for the fiber solutions. In this regard, with reference to the flowchart in FIG. 13, when the user selects the “Refine project costs” button 100 in the fiber solutions costs UI window 64 in FIG. 3, the FPE tool 181 displays the refine project costs UI window 288. The user can input average overhead per engineer per day in an overhead field 290 (block 300 in FIG. 13). The user can also input whether certain tasks 292 are outsourced or in-sourced, wherein this indication affects costs (block 296 in FIG. 13). If no input is received from the user for these selections (blocks 296 and 300 in FIG. 13), the FPE tool 181 will assume that all tasks 292 are in-sourced, and a default overhead will be used for the overhead per engineer day (blocks 298 and 302 in FIG. 13).

With continuing reference to FIG. 13, the FPE tool 181 estimates the number of days required for all engineering and project management tasks, scaled with take rate and method of installation, according to models for the fiber solutions sub-categories 70 (block 304). The FPE tool 181 then calculates the project management costs and engineering costs for each fiber solution by multiplying the number of days for each task by the overhead either specified by the user in the overhead field 290 in FIG. 12 or the default overhead rate (block 306). After a “Save” button 294 is selected by the user, the FPE tool 181 then sums the costs for these tasks that the user selected as in-sourced or out-sourced, or in-sourced by default if no user selection was made, and as a function of size, density, and method of fiber optic cable installation and take rate to provide updated cost estimates for the fiber solutions (block 308).

FIG. 14 is a flowchart illustrating the FPE tool 181 processing average monthly subscription and take rate inputs previously described as being able to be entered by a user into the fiber solutions costs UI window 64 in FIG. 3. If the user enters an average monthly subscription rate in the average monthly subscription rate field 114 in FIG. 3 (block 310 in FIG. 14), the FPE tool 181 draws from the number of days for project management to determine how long the total installation will take for each fiber solution (block 312). The FPE tool 181 will multiple the number of homes in the build area for the fiber project by the expected take rate, and then multiply this result by the average revenue per subscriber and scale (block 314). If the user provides an expected take rate via the expected take rate slider 122 in (FIG. 3) (block 318 in FIG. 14), the FPE tool 181 will update the take rate over the default take rate. The FPE tool 181 will then multiple this result again by the number of days required to build the fiber optic network for the fiber project (block 314). This results in the forgone revenue opportunity cost component (block 314). The FPE tool 181 then uses the determined forgone revenue opportunity cost component to provide as part of the total cost estimates for the fiber solutions sub-categories 70 (block 316).

FIG. 15 is a flowchart illustrating the FPE tool 181 processing expected take rate as function of time and whether speed of deployment is critical. These user-definable inputs were previously described. In this regard, the FPE tool 181 can prompt a user for his/her expected take rate as a function of time, as provided in the fiber solutions costs comparison UI window 131 in FIG. 4 (block 320). In this regard, the FPE tool 181 can also prompt a user if speed of deployment is critical as previously discussed and illustrated in the fiber solutions costs comparison UI window 131 in FIG. 4 (block 322). In response to either, the FPE tool 181 performs logic to identify which of the fiber solutions sub-categories 70 is recommended by the FPE tool 181 (block 324). If opt to defer in the cost factor input area 118 in FIG. 3 was selected, the fiber solutions sub-categories 70 are compared and the least expensive of the options are recommended in the recommendation area 92 in FIG. 3. If the user indicated as an input that speed of deployment was critical in FIG. 3, and the recommended fiber solutions are within a certain tolerance of each other, the faster of the recommended fiber solutions is recommended (block 324). If the user selected opt to defer, the same logic is performed on fiber solutions at a zero percent (0%) take rate (block 324). The FPE tool 181 then determines the cost estimates for the subset of fiber solution sub-categories 70 (block 330).

With continuing reference to FIG. 15, the FPE tool 181 also generates the estimated cash flow by year for the subset of fiber solutions (block 326) and generates or updates the estimated cash flow by year graph 134, as illustrated in FIG. 4 (block 328). The FPE tool 181 is configured in this embodiment to determine the breakeven point where the cumulative cash flow breaks even with the cumulative deployment costs, as illustrated in FIG. 4 (block 326). Depending on the breakeven point, the X-axis of the estimated cash flow by year graph 134 may be adjusted by the FPE tool 181 to provide mean data on both sides of the breakeven point (block 326).

FIGS. 16A-16C-2 are reports that can be generated by the FPE tool 181 for the fiber project as a result of the user printing the results of the fiber project. For example, the user can select the “Print my results” button 126 in the fiber solutions costs UI window 64 in FIG. 3, as previously discussed. The reports in FIGS. 16A-16C-2 contain common data to that previously described above, but in report format, and thus such is provided with common element numbers and will not be re-described. A listing report of all inputs, user-defined and default, used by the FPE tool 181 to provide the cost information in FIG. 16A is provided in a report listing 340 in FIG. 16B. Fiber optic drop cable placement data 342 not previously described in detail is provided in the report listing 340, as illustrated in FIG. 16B. FIGS. 16C-1 and 16C-2 provide an overall listing 344 of the equipment and cable needed for the subset of fiber solutions sub-categories 70 selected for comparison in the fiber solutions costs UI window 64 in FIG. 3. The listing includes a part number column 346, a description of the part column 348, a quantity column 350, and a product literature column 352. Thus, the listing 344 can be used to provide an order form or to otherwise have a parts list needed for the fiber project.

FIG. 17 is a schematic diagram of exemplary FPE tool and database computing and networking architecture embodiments to allow one or more users, either locally or distributed among different locations, to use an FPE tool to create, store, share, and/or manipulate FPEs and associated data locally, at a central server, which may include a web server as an example, using a network database, and/or in a peer-to-peer fashion. In this regard, FIG. 17 illustrates an exemplary FPE tool and database computing and networking architecture 360 that may be employed to allow users to access the FPE tool 181 to generate cost estimates for fiber solutions. The FPE tool 181 is adapted to execute on a computer. The computer may be a user computer or client 362 or may be a server 364, which may be located at a central location. In either case, a user 366 interacts with a user computer 362 or other interface to access the FPE tool 181. The user 366 is not required to have any programming knowledge or expertise to use the FPE tool 181. If the FPE tool 181 is executing on the user computer 362, an FPE tool database 368 may also be provided locally at the user computer 362 configured to store fiber projects created by the user 366 using the FPE tool 181. Previously created and stored fiber projects using the FPE tool 181 can be retrieved and reviewed and the input data for such fiber projects changed to generate revised cost estimates.

If the FPE tool 181 is executing on the server 364 or other remote location from the user 366, the user computer 362 may act as a client in a client-server architecture to access the FPE tool 181 located at the server 364. The FPE tool 181 may be accessible by more than one user via the clients 362. Typically, the clients 362 will connect to the server 364 or other device that is executing the FPE tool 181 over a network 370, such as a TCP/IP-based network for example, and typically through an information service provider (ISP) 372. The server 364 receives a connection request from the clients 362 over the network 370 via its ISP 374. As an example, the server 364 could include a web server that provides the UIs discussed herein as web pages to be received and displayed on the user computer 362 using an Internet transfer protocol, including but not limited to HyperText Transfer Protocol (HTTP). The user computer 362 could include a browser configured to access the server 364 to request web pages and to display received web pages from the server 364.

The user 366 provides selections and receives responses from the FPE tool 181, via the client 362, when creating and managing service-oriented candidates. In this example, the FPE tool database 368 may be located locally at the server 364, or provided as a network database hanging off the network 370 and accessible to the server 364 and/or client 362. A client-server architecture may be useful for allowing multiple users in different locations to work on the same fiber project and/or to provide the FPE tool 181 in an application services provider (ASP) configuration. Also note that a peer-to-peer architecture can also be employed, wherein one of the clients 362 is executing the FPE tool 181 as a super peer, and one or more other clients 362 can access the FPE tool 181 via the super peer client 362.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.), etc.

Unless specifically stated otherwise as apparent from the following discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the teachings herein.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The FPE tool and computer-readable media discussed herein may be provided in an electronic device and/or processor-based device or system. Examples of such devices include, without limitation, a set top box, an entertainment unit, a navigation device, a communications device, a personal digital assistant (PDA), a fixed location data unit, a mobile location data unit, a mobile phone, a cellular phone, a computer, a portable computer, a desktop computer, a processor-based device, a controller-based device, a monitor, a computer monitor, a television, a tuner, a radio, a satellite radio, a music player, a digital music player, a portable music player, a video player, a digital video player, a digital video disc (DVD) player, and a portable digital video player.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A graphical user interface (GUI) on an electronic device with memory and one or more processors to execute one or more programs stored in the memory to provide cost estimates for a fiber project, comprising:
a graph area comprised of:
a first axis corresponding to a plurality of fiber solutions for a fiber project;
a second axis corresponding to cost of the fiber project; and
a plurality of fiber solutions cost graphs each corresponding to one of the plurality of fiber solutions in the first axis and a total cost of the fiber project for the corresponding one of the plurality of fiber solutions in the second axis; and
at least one fiber project cost-related input field corresponding to at least one cost-related factor in the total cost of a fiber project and configured to receive a cost-related input from a user that causes the total cost of the fiber project for each of the plurality of fiber solutions cost graphs to be dynamically updated in the graph area based on the cost-related input.

2. The GUI on the electronic device of claim 1, wherein the plurality of fiber solutions cost graphs are comprised of a plurality of bar graphs.

3. The GUI on the electronic device of claim 1, wherein the plurality of fiber solutions cost graphs are each comprised of a plurality of cost components contributing to the total cost.

4. The GUI on the electronic device of claim 3, further comprising a cost component legend identifying each of the plurality of cost components contributing to the total cost in the plurality of fiber solutions cost graphs.

5. The GUI on the electronic device of claim 1, wherein the plurality of fiber solutions are comprised of at least one spliced fiber solution, at least one spliced and preconnectorized fiber solution, and at least one preconnectorized solution.

6. The GUI on the electronic device of claim 1, further comprising a plurality of comparison selection inputs each corresponding to a fiber solution among the plurality of fiber solutions.

7. The GUI on the electronic device of claim 1, wherein the at least one fiber project cost-related input field is comprised of at least one fiber project cost-related input slider.

8. The GUI on the electronic device of claim 1, wherein the at least one fiber project cost-related input field is comprised of at least one of a fiber optic distribution cable breakdown input, a fiber optic drop cable breakdown input, a labor rate input, a fiber project cost input, a fiber project density input, a number of homes in fiber project input, an average lot frontage in fiber project input, a fiber project deployment input, a speed of deployment critical input, an average monthly subscription rate input, a fiber project subscription rate input, an expected take rate input, and a deferment input.

9. The GUI on the electronic device of claim 1, wherein the electronic device is comprised from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the electronic device is integrated.

10. The GUI on the electronic device of claim 1 received from a server.

11. The GUI on the electronic device of claim 10, wherein the server is comprised from the group consisting of a local server, a remote server, a network server, and a web server.

12. A computer-readable medium storing one or more programs, the one or more programs comprising instructions, which when executed by an electronic device cause the electronic device to display a graphical user interface (GUI) to provide cost information for a fiber project, the GUI comprising:
a graph area comprised of:
a first axis corresponding to a plurality of fiber solutions for a fiber project;
a second axis corresponding to cost of the fiber project; and
a plurality of fiber solutions cost graphs each corresponding to one of the plurality of fiber solutions in the first axis and a total cost of the fiber project for the corresponding one of the plurality of fiber solutions in the second axis; and
at least one fiber project cost-related input field corresponding to at least one cost-related factor in the total cost of a fiber project and configured to receive a cost-related input from a user that causes the total cost of the fiber project for each of the plurality of fiber solutions cost graphs to be dynamically updated in the graph area based on the cost-related input.

13. The computer-readable medium of claim 12, wherein the instructions further cause the electronic device to display the plurality of fiber solutions cost graphs as a plurality of bar graphs.

14. The computer-readable medium of claim 13, wherein the instructions further cause the electronic device to display a plurality of comparison selection inputs each corresponding to a fiber solution among the plurality of fiber solutions.

15. The computer-readable medium of claim 13, wherein the instructions further cause the electronic device to display at least one fiber project cost-related input field comprised of at least one fiber project cost-related input slider.

16. The computer-readable medium of claim 13, wherein the instructions further cause the electronic device to display at least one fiber project cost-related input field of at least one fiber project cost-related input slider.

17. A graphical user interface (GUI) on an electronic device with memory and one or more processors to execute one or more programs stored in the memory to provide cost information for a fiber project, comprising:
an incremental fiber cost by year graph comprised of a first axis corresponding to a time period for a fiber project, a second axis corresponding to a total cost of the fiber project, and a plurality of fiber solutions cost graphs each corresponding to the total cost of the fiber project in the first axis and the time period in the second axis;
an estimated cash flow by year graph comprised of a first axis corresponding to the time period for the fiber project, a second axis corresponding to cash flow of the fiber project, and a plurality of fiber solutions cash flow graphs each corresponding to cash flow of the fiber project in the first axis and the time period in the second axis; and
a take rate input area comprised of a plurality of expected take rate input fields each corresponding to a time period and each configured to receive expected take rate inputs from a user that cause the cash flow of the fiber project for each of the plurality of fiber solutions cash flow graphs to be dynamically updated based on the expected take rate inputs.

18. The GUI on the electronic device of claim 17, wherein the plurality of fiber solutions cost graphs are comprised of a plurality of bar graphs.

19. The GUI on the electronic device of claim 18, further comprising a fiber solutions legend identifying each of the plurality of fiber solutions cost graphs, and identifying each of the plurality of fiber solutions cash flow graphs.

20. The GUI on the electronic device of claim 17, further comprising at least one density input field and at least one subscription rate field, each configured to receive a density input and a subscription rate input, respectively, from a user that causes the plurality of fiber solutions cost graphs and the plurality of fiber solutions cash flow graphs to be dynamically updated.

21. The GUI on the electronic device of claim 17, wherein the at least one fiber project cost-related input field is comprised of at least one fiber project cost-related input slider.

22. The GUI on the electronic device of claim 17, wherein the electronic device is comprised from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the electronic device is integrated.

23. The GUI on the electronic device of claim 17 received from a server.

24. The GUI on the electronic device of claim 23, wherein the server is comprised from the group consisting of a local server, a remote server, a network server, and a web server.

25. A computer-readable medium storing one or more programs, the one or more programs comprising instructions, which when executed by an electronic device cause the electronic device to display a graphical user interface (GUI) to provide cost information for a fiber project, the GUI comprising:
an incremental fiber cost by year graph comprised of a first axis corresponding to a time period for a fiber project, a second axis corresponding to a total cost of the fiber project, and a plurality of fiber solutions cost graphs each corresponding to the total cost of the fiber project in the first axis and the time period in the second axis;
an estimated cash flow by year graph comprised of a first axis corresponding to the time period for the fiber project, a second axis corresponding to cash flow of the fiber project, and a plurality of fiber solutions cash flow graphs each corresponding to cash flow of the fiber project in the first axis and the time period in the second axis; and
a take rate input area comprised of a plurality of expected take rate input fields each corresponding to a time period and each configured to receive expected take rate inputs from a user that cause the cash flow of the fiber project for each of the plurality of fiber solutions cash flow graphs to be dynamically updated based on the expected take rate inputs.

26. The computer-readable medium of claim 25, wherein the instructions further cause the electronic device to display the plurality of fiber solutions cost graphs as a plurality of bar graphs.

27. The computer-readable medium of claim 25, wherein the instructions further cause the electronic device to display at least one density input field and at least one subscription rate field, each configured to receive a density input and a subscription rate input, respectively, from a user that causes the plurality of fiber solutions cost graphs and the plurality of fiber solutions cash flow graphs to be dynamically updated.

28. The computer-readable medium of claim 25, wherein the instructions further cause the electronic device to display at least one fiber project cost-related input field of at least one fiber project cost-related input slider.
